SEQUENCE LISTING (7 sequences)

SEQ ID NO: 1 - RNA, 62 nt, Haloarcula marismortui
uuaggcggccacagcggugggguugccucccguacccaucccgaacacggaagauaagccca

SEQ ID NO: 2 - RNA, 65 nt, Deinococcus radiodurans
acacccccgugcccauagcacuguggaaccaccccaccccaugccgaacugggucgugaaacaca

SEQ ID NO: 3 - RNA, 62 nt, Deinococcus radiodurans
cccccgugcccauagcacuguggaaccaccccaccccaugccgaacugggucgugaaacaca

SEQ ID NO: 4 - RNA, 14 nt, Artificial Sequence
  Synthetic
ggcggugaaaugcc

SEQ ID NO: 5 - RNA, 13 nt, Artificial Sequence
  Synthetic
agacugaagaucu

SEQ ID NO: 6 - RNA, 122 nt, Haloarcula marismortui
uuaggcggccacagcggugggguugccucccguacccaucccgaacacggaagauaagcccaccagcguuccggggaguacuggagugcgcgagccucugggaaacccgguucgccgccacc

SEQ ID NO: 7 - RNA, 124 nt, Deinococcus radiodurans
acacccccgugcccauagcacuguggaaccaccccaccccaugccgaacugggucgugaaacacagcagcgccaaugauacucggaccgcagggucccggaaaagucggucagcgcggggguuu

(19) United States
(12) Patent Application Publication
(10) Pub. No.: US 2011/0112816 A1
(43) Pub. Date: May 12, 2011

(54) SYSTEM AND METHODS FOR THREE DIMENSIONAL MOLECULAR STRUCTURAL ANALYSIS

(76) Inventors: John Santalucia, Grosse Pointe Woods, MI (US); Pirro Saro, New Haven, CT (US); Donald Hicks, Ann Arbor, MI (US)

(21) Appl. No.: 12/915,895

(22) Filed: Oct. 29, 2010

Related U.S. Application Data
(62) Division of application No. 10/578,946, filed on Feb. 5, 2007.
(60) Provisional application No. 60/518,220, filed on Nov. 7, 2003.

(51) Int. Cl. G06G 7/58

(52) U.S. Cl. 703/11

(57) ABSTRACT

The present invention relates to methods and systems for the accurate prediction of nucleic acid, e.g., RNA and DNA, and other macromolecular and biomolecular three-dimensional structure from sequence and constraint information.

The present Application is a Divisional of U.S. application Ser. No. 10/578,946, filed Feb. 5, 2007, which is a 371 U.S. National Entry of PCT/US2004/037291, filed Nov. 8, 2004, which claims priority to U.S. Provisional Application 60/518,220, filed Nov. 7, 2003, each of which is herein incorporated by reference in their entireties.

### FIELD OF THE INVENTION

The present invention relates to methods and systems for the accurate prediction of nucleic acid (e.g., RNA and DNA) and other macromolecular three-dimensional structure from sequence and constraint information.

### BACKGROUND OF THE INVENTION

The structures formed by macromolecules are generally essential to their function. For example, tRNA structure is critical to its proper function in being recognized by the cognate tRNA synthetase and binding to the ribosome and correct mRNA codon, ribosomal RNA (rRNA) structures are essential to the correct function of the ribosome, and correct folding is essential to the catalytic function of Group I self-splicing introns (See e.g., the chapters by Woese and Pace (p. 91), Noller (p. 137), and Cech (p. 239) in Gesteland and Atkins (eds.), The RNA World, Cold Spring Harbor Laboratory Press, Cold Spring Harbor, N.Y. [1993]). Folded structures in viral RNAs have been linked to infectivity (Proutski et al., J Gen Virol., 78(Pt 7):1543-1549 [1997], altered splicing (Ward, et al., Virus Genes 10:91 [1995]), translational frameshifting (Bidou et al., RNA 3:1153 [1997]), packaging (Miller, et al. J Virol., 71:7648 [1997]), and other functions. In both prokaryotes and eukaryotes, RNA structures are linked to post-transcriptional control of gene expression through mechanisms including attenuation of translation (Girelli et al., Blood 90:2084 [1997], alternative splicing (Howe and Ares, Proc. Natl. Acad. Sci. USA 94:12467 [1997]) and signaling for RNA degradation (Veyrune et al, Oncogene 11:2127 [1995]). Messenger RNA secondary structure has also been associated with localization of that RNA within cells (Serano and Cohen, Develop., 121:3809-3818 [1995]). In DNA, it has been shown that cruciform structures have been tied to control of gene expression (Hanke et al., J. Mol. Biol., 246:63 [1995]). It can be seen from these few examples that the use of folded structures as signals within organisms is not uncommon, nor is it limited to non-protein-encoding RNAs, such as rRNAs, or to non-protein-encoding regions of genomes or messenger RNAs.

Most current software for macromolecular modeling has been developed to primarily deal with proteins and such software lacks needed functionality for modeling of nucleic acids. This is true of both commercial software (e.g., InsightII (Biosym) and Sybyl (Tripos)) and free software (e.g., Swiss PDBviewer and RASMOL). For example, most of the functionality in SwissPDBviewer v3.7 does not work for nucleic acids (non-functional components include computation of electrostatic potential, forcefield energy, detect secondary structure, mutation of residues, and the build functions). The “Calculate H-bonds” option of SwissPDBviewer misses about 20% of the known H-bonds in tRNA, and predicts the presence of several H-bonds that are actually impossible. Software for computing helical parameters and bond dihedrals has been written including CURVES, NEWHELIX, 3DNA (Lu, X.-J. & Olson, W. K. (2003) Nucleic Acids Res. 31, 5108-21; Layery, R. & Sklenar, H. (1988) J. Biomol. Struct. Dyn. 6, 739-1102; Layery, R. & Sklenar, H. (1989) J. Biomol. Struct. Dyn. 6, 655-67; Dickerson, R. E. (1998) Nucleic Acids Res. 26, 1906-26.). Projects are underway in the labs of Neocles Leontis, Eric Westhof, Steven Holbrook and others to automatically compute motifs in RNA (Yang, H., et al., (2003) Nucleic Acids Res. 31, 3450-60; Hershkovitz, E., et al., (2003) Nucleic Acids Res 31, 6249-57; Klosterman, P. S., et al., (2002) Nucleic Acids Res. 30, 392-4; Leontis, N. B. & Westhof, E. (2002) Biochimie 84, 961-973; Gautheret, D. & Lambert, A. (2001) J Mol Biol 313, 1003-11).

Current software for tertiary structure predictions of nucleic acids. Prior to 1990, there were several attempts to predict tRNA tertiary structure, with very little success even given the secondary structure, FRET data, crosslinking data, and chemical protection data (Hubbard, J. M. & Hearst, J. E. (1991) Biochemistry 30, 5458-65.). In 1990, Michel and Westhof published their classic predicted structure of the group I intron, using manual modeling. This brought together all of the then available experimental biochemical and genetic data (Michel, F. & Westhof, E. (1990) J Mol Biol 216, 585-610). After the crystal structure became available, it was clear that much of the predicted structure was qualitatively correct while many of the finer details were not. Later the Westhof group developed the program MANIP, which allows an expert user to manually link together fragments and rotate them into a desired location (Massire, C. & Westhof, E. (1999) J. Mol. Graphics. Modeling 16, 197-205). MANIP was used to create a model of RNaseP 32; 33(Tsai, H.-Y., et al., 2003 J. Mol. Biol. 325, 661-675; Massire, C., Jaeger, L. & Westhof, E. (1998) J. Mol. Biol. 279, 773-93) but an X-ray structure is not yet available to evaluate its accuracy. Major and Cedergren wrote MC-SYM to automatically predict the structures of small RNAs by iteratively mixing and matching base pairs, mismatches, and dimer rotamers from a structure database using a forcefield energy to rank candidate structures (Major, F., et al., (1991) Science 253, 1255-60; Gautheret, D., Major, F. & Cedergren, R. (1993) J. Mol. Biol. 229, 1049-1064). MC-SYM, however, is computationally intensive and cannot be easily used to model large RNA structures and the motif library, method of assembly, and optimization methods are completely different than that described in the present invention. Heinz Sklenar's group has developed JUMNA to perform conformational searches in small hairpin loops (Maier, A., et al., (1999) Eur. Biophys. J. Biophys. Lett. 28, 564-73). Macke and Case developed the Nucleic Acid Builder (NAB; Macke, T. J. & Case, D. A. (1998) ACS Symposium Ser. 682, 379-93), which allows users to link together motifs to create rough structures but these require manual refinement by an expert human before they are suitable for AMBER refinement, but the quality of the predictions have not been critically evaluated to date. ERNA-3D was written by Mueller and Brimacombe to model the ribosome (Mueller, F. & Brimacombe, R. (1997) J. Mol. Biol. 271, 524-544; Mueller, F. & Brimacombe, R. (1997) J. Mol. Biol. 271, 545-565; Mueller, F., et al., (2000) J. Mol. Biol. 298, 35-59) and has been used to model the SRP RNA41. Wilma Olson's group has written software (3DNA) to assemble double helix structures given helical parameters, but this software does not model single-stranded structures (Lu and Olson, 2003, supra). In 2000, the first homology model of the ribosomal small subunit of E. coli was constructed from the X-ray structure of T. thermophilus (Tung, C. S., et al., (2002) Nature Struct. Biol. 9, 750-5; Tung, C. S. (1996) J Biomol Struct Dyn 14, 153-61). The homology model was validated against the cryo-electron microscopy low resolution electron density. Notably, however, the homology model was manually constructed using an expert human at all steps of the modeling process.

Rapid determination of nucleic acid structure would be a useful tool for basic and clinical research and for diagnostics. Accurate identification of nucleic acid structures would facilitate the design and application of therapeutic agents targeted directly at nucleic acids and related molecules.

Methods for the experimental determination of nucleic acid and other macromolecular structure (e.g., NMR and X-ray crystallography), cannot keep pace with the exponential growth of databases of the primary sequences of such macromolecules. Thus, there is a need to develop tools for the prediction of structure from directly from sequence information.

### SUMMARY OF THE INVENTION

The present invention relates to methods and systems for the accurate prediction of nucleic acid (e.g., RNA and DNA, and other biomolecular mimics) three-dimensional structure from sequence and constraint information. In preferred embodiments, the test sequence that is analyzed by the systems and methods of the present invention is DNA or RNA. In some embodiments, the systems are automated and are used to generate large numbers of three-dimensional structures from sequences stored in databases (e.g., public and private nucleic acid sequence databases). A wide variety of applications of the invention exist, including, but not limited to, basic research applications, diagnostic applications, therapeutic applications, and drug screening applications. In addition, the systems and methods of the present invention allow for rational design of folded nucleic acid molecules (with and without other associated ions and other molecules such as water, proteins, prosthetic groups, multivalent ligands, and crosslinking agents), to generate novel materials, catalysts, and nanotechnologies.

For example, the present invention provides systems and methods for generating corrected three-dimensional models of nucleic acids and other biomolecules. Initial models from NMR or X-ray crystallography or electron microscopy or other techniques often have significant structural errors in bond lengths, bond angles, non-optimal hydrogen bonds, steric clashes, particularly involving hydrogen atoms, missing atoms, missing bases, missing whole residues, missing whole sections of the sequence, incorrectly assigned O1P and O2P or H5′ and H5″ stereochemistries, and other nomenclature problems. Structural errors may also be present in structures generated by using traditional modeling techniques or techniques of the present invention. The initial models are improved (made more accurate, or “corrected”) by the systems and methods of the present invention. In preferred embodiments, the systems comprise a processor that is configured to carry out one or more of the following tasks:
a) generate an initial, uncorrected model of a test sequence (e.g., an sequence with unknown structure, a sequence with partially known structure, etc.) by comparison to a reference sequence (i.e., a sequence with known structure);
b) align the reference sequence with the test sequence subject to the secondary structure constraints (see Detailed Description) using the SBSA algorithm of the present invention, or derivatives thereof, to generate an aligned sequence;
c) make substitutions, deletions, and insertions dictated by the aligned sequence (see Detailed Description) using geometrical computation algorithms for the substitutions and using molecular mechanics, molecular dynamics algorithms, and other algorithms (such as the Discrete Sampling of Torsion Angles with Rigid-body Rotations and Optimization) to close gaps caused by the deletions and insertions as well as other modeling imperfections;
d) automatically identify conserved hydrogen bonds present in both the reference sequence and the uncorrected model to select hydrogen bond constraints;
e) allow input of other constraints determined by experimental or theoretical techniques, including distances, dihedral angles, bond vectors, electron density, and accessibility to chemical modifying agents; and
f) optimize the uncorrected model using a forcefield algorithm to generate a corrected three-dimensional model of the test sequence that is consistent with selected and input constraints.

The present invention also provides methods that employ the system to generate corrected three-dimensional models of test sequences. Such test sequences may include but are not limited to naturally occurring homologs found in public or private sequence databases, may be mutants found naturally, generated in the laboratory, or generated in silico.

The present invention further provides systems and methods for predicting biomolecular three-dimensional structure, either de novo or where some structural information is known about a test sequence that is to be analyzed. In some such embodiments, the present invention provides systems for predicting nucleic acid three-dimensional structure, where the system comprises a processor configured to carry out one or more of the following tasks:
a) compute one or more secondary structures of a test nucleic acid (e.g., using standard secondary structure prediction methods known in the art and/or those described herein);
b) decompose the secondary structures into nucleic acid structure motifs (e.g., base pairs, hairpins, bulges, internal loops, etc.);
c) rank the structure motifs in a hierarchal tree (i.e., an organizational structure that prioritizes motifs by category and defines an interrelationship between the different categories of motifs—e.g., hairpins as the “leaves”, internal loops and bulges as the “branches”, and multiloops and bifurcations as sub-roots and roots, respectively);
d) identify candidate three-dimensional motif structures for the motifs from a database of known three-dimensional structure motifs (e.g., for each motif, select similar structures from a motif structure database);
e) link together the candidate three-dimensional motif structures in an order specified by the hierarchal tree to generate one to several candidate three-dimensional composite structure(s);
f) submit each candidate three-dimensional composite structure to an energy minimization algorithm (e.g., AMBER, CHARMM, the methods of the present invention, etc.) to generate a refined candidate three-dimensional structure/s;
g) rank the refined candidate three-dimensional structures based on the calculated total energy and other scoring parameters such as solvent accessible surface area, molecular density, non-bonded energy or weighted combination of these parameters.
h) select one or more of the highest-ranking three-dimensional structures of the test sequence for further refinement using the best available molecular dynamics and mechanics software with implicit or explicit solvation and counterions. (e.g., selecting the structure, among many that are generated, with the lowest total energy) to predict a three-dimensional structure of the test nucleic acid.

In some embodiments, the candidate three-dimensional motif structures comprise known secondary structure elements (e.g., known from phylogeny [e.g., comparative sequence analysis], known from experimental methods [e.g., site directed mutagenesis, chemical probing, nuclease probing, etc.], etc.). In some preferred embodiments, the refined candidate three-dimensional structure is selected by ranking a plurality of such structures by total energy defined by the sum of forcefield energy (see Detailed Description) and secondary structure folding energy from a dynamic programming algorithm (e.g., Visual OMP—see below). The present invention also provides methods for generating a three-dimensional structure of test nucleic acids using such systems.

The present invention also provides systems and methods for generating and managing biomolecule structure motif databases (e.g., for use in the methods above). For example, the present invention provides systems comprising a processor that is configured to carry out one or more of the following tasks:
a) receive nucleic acid physical structure information (e.g., sequence, location of modified nucleotides, structural annotations, secondary structure, crystallographic B-factors, three dimensional coordinates or dihedral angles of the macromolecule, water molecules, counterions, bound proteins, other bound ligands, etc.);
b) decompose said physical structure information into nucleic acid structure motifs;
c) automatically determine hydrogen bonds, base pairs, mismatches, and a variety of folding motifs (stacking, U-turns, A-platforms, coaxial stacking, etc.)
d) associate data with said structure motifs, said data comprising one or more of: sequence of the motif, type of motif (hairpin, bulge, internal loop, multiloop, mismatch, coaxial stack), size of motif, coordinates of backbone (e.g., xyz coordinates, ribose-phosphate for RNA, deoxyribose-phosphate for DNA, modified backbone for modified nucleic acids), source of the coordinates (e.g., Protein Data Bank accession number), reliability parameter (i.e., the resolution, a score or indication of the reliability of the source of the information), sequences known to form a motif, and dihedral angles for bases;
e) compare the nucleic acid structure motifs to existing motifs in the database; and
f) add the structure motif and associated data to said database.

In preferred embodiments, the coordinates in the database are derived from NMR and X-ray structures, other experimental techniques (e.g., cryo-electron microscopy, atomic force microscopy, fluorescence resonance energy transfer), or previously predicted structures from the invention (e.g., in some embodiments the invention can “learn” from each example for which it is used), or other sources, or are obtained from databases or literature references. In some embodiments, the comparison is carried out by determining the root mean squared deviation of the new motif to the existing motifs to determine whether the motif is unique in the database. In some embodiments, whether the new motif is unique to the database or not, the motif is still cataloged in the database. The present invention also provides methods for generating a nucleic acid structure motif database using the above system.

The present invention further provides systems and methods for refining nucleic acid structure predictions. For example, the present invention provides a system for refining nucleic acid structure predictions comprising a processor configured to carry out one or more of the following tasks:
a) calculate energy minimization terms for a test nucleic acid structure prediction model, said energy minimization terms comprising: bond stretching, bond angles, torsion stress, and non-bonded interactions (e.g., van der Waals, hydrogen bond, Coulomb electrostatics) with special functional forms for overlapping atoms (e.g., close van der Waals contacts from nucleotide insertions or poor initial modeling geometries) and long bond lengths (for example from nucleotide deletions);
b) optimize force constants, distance dependence function, partial charges, and van der Waals radii parameters;
c) account for gap penalties for insertions or deletions, if present in the prediction model (e.g., present because of the use of methods of the present invention);
d) account for one or more experimental constraints associated with said test nucleic acid, said experimental constraints comprising hydrogen bonding information, positions of phosphorus atoms, nuclear Overhauser effect information, residual dipolar coupling information, x-ray crystallographic electron density, cryo-electron microscopy electron density information, and chemical probing information;
e) employ distance constraints within a defined distance range but ignore distance constraints outside of said defined distance range; and
f) account for one or more nucleic acid folding thermodynamic measures, said nucleic acid folding thermodynamic measures comprising: folding entropy changes and solvation entropy changes as well as enthalpy and free energy changes at different temperature, salt, and other solution conditions.
g) Account for known interactions with proteins, metal ions, or other ligands by setting “anchor points” (see Detailed Description).

In some embodiments, the folding entropy and solvation entropy are obtained from solution measurements (e.g., UV absorbance melting curves and calorimetric measurements known in the scientific literature) and decomposed into motif parameters (e.g., parameters for base pairs, mismatches, and loops of various sizes such as hairpins, internal loops, multi-loops, and bulges). The present invention also provides methods for refining a nucleic acid structure prediction using such systems.

The present invention also provides systems and methods for the identification of conserved hydrogen bonds for use in generating three-dimensional biomolecule structure prediction. The systems and methods employ one or more of the following steps:
a) identification of all hydrogen bonds in a nucleic acid structure (e.g., using prediction algorithms know in the art or described herein) utilizing the positions, distances, angles, and dihedral angles of both heavy atoms and hydrogen atoms;
b) analysis of identified hydrogen bonds to determine if the nucleotides participate in Watson-Crick base pairs, mismatches, base-backbone interactions, and/or backbone/backbone interactions;
c) analyze the co-planarity of bases to confirm the presence of Watson-Crick base pairs; and
d) compare hydrogen bonds between reference sequences and test sequences to identify correct hydrogen bonds in the test sequences.

### DEFINITIONS

As used herein, the term “nucleic acid” refers to strands comprising backbones (e.g., of ribose phosphate and deoxyribose phosphate) and side chains generally comprising heterocyclic bases such as A, C, G, T, and U. Nucleic acids comprise “natural” nucleic acids, i.e., those comprising natural backbones of ribose phosphate and deoxyribose phosphate, and side chains comprising the most common heterocyclic bases: A, C, G, T, and U. Examples of natural nucleic acids include deoxyribonucleic acid (DNA) and ribonucleic acid (RNA).

As the term is used herein, nucleic acids also comprise synthetic analogs of DNA or RNA in which the backbone and/or base moieties are substituted. Examples of synthetic nucleic acids include but are not limited to PNA (Nielsen P E, et al., Science 254 (5037): 1497-1500 Dec. 6 1991), LNA (Petersen M., et al., Nucleosides Nucleotides & Nucleic Acids 22 (5-8): 1691-1693 2003), TNA (Chaput J C, Szostak J W (2003) J Am Chem Soc 125 (31): 9274-9275), 2′-O-methyl-RNA (Schubert S, et al., (2003) Nucleic Acids Res. 31 (20): 5982-5992), MOE (Vickers T A, et al., Nucleic Acids Res. 29 (6): 1293-1299 Mar. 15 2001), 2′-fluoro (Shimizu M., et al., FEBS Letters 302 (2): 155-158 May 11, 1992), Hexose (Eschenmoser A, Hexose Nucleic-Acids, Pure Appl Chem 65 (6): 1179-1188 June 1993), 3-nitro-pyrrole, 5-nitro-indol, etc.

Nucleic acids may be single stranded, double stranded or may comprise both single and double stranded regions. Nucleic acids may comprise unimolecular folds, may comprise duplexes with strands of equal length or, in the case of a short oligo hybridizing to a long oligonucleotide, for example, may comprise an intermolecular duplex and tails that fold to form an intramolecular duplex or other structure. Nucleic acids may also comprise multiple stranded structures in which more than two strands of nucleic acid associate to form a higher order structure.

The terms “analog” and “modified” are used interchangeably herein in reference to bases, nucleosides and nucleotides other than the most common bases, sugars, and nucleotides, i.e., A, G, C, U, dA, dC, dG, and dT. Such analogs and modified bases and nucleotides include modified natural nucleotides in DNA and RNA and non-naturally occurring nucleotides, including but not limited to N4-acetyl-C, 5-methyl-C, m4Cm, inosine, 2-thio-U, dihydro-U, pseudo-U, N3-methyl-pseudo-U, N3-methyl-U, 4-thio-U, rT, Y-base, 2′-O-methyl A, C, G, U, N2-methyl-G, N7-methyl-G, N6-methyl-A, N6-dimethyl-A, 1-methyl A, 2-methyl A, O6-methyl G, and hydroxyl methyl T, and a variety of natural product adducts such as acetylamino fluorine, benzopyrene, mitomycin, neocarcinostatin, etc. At least 95 naturally occurring modifications have been observed in RNA and DNA (Rozenski J, et al., The RNA modification database: 1999 update, Nucleic Acids Res 27 (1): 196-197 Jan. 1 1999). Analogs and modified nucleotides include those that have altered stacking interactions, such as 7-deaza purines (i.e., 7-deaza-dATP and 7-deaza-dGTP); base analogs with alternative hydrogen bonding configurations (e.g., such as iso-C and iso-G and other non-standard base pairs described in U.S. Pat. No. 6,001,983 to S. Benner, and the selectively binding base analogs described in U.S. Pat. No. 5,912,340 to Igor V. Kutyavin, et al.); non-hydrogen bonding analogs (e.g., non-polar, aromatic nucleoside analogs such as 2,4-difluorotoluene, described by B. A. Schweitzer and E. T. Kool, J. Org. Chem., 1994, 59, 7238-7242, B. A. Schweitzer and E. T. Kool, J. Am. Chem. Soc., 1995, 117, 1863-1872); “universal” bases such as 5-nitroindole and 3-nitropyrrole; and universal purines and pyrimidines (such as “K” and “P” nucleotides, respectively; P. Kong, et al., Nucleic Acids Res., 1989, 17, 10373-10383, P. Kong et al., Nucleic Acids Res., 1992, 20, 5149-5152). Nucleotide analogs include modified forms of deoxyribonucleotides as well as ribonucleotides, as well as those comprising sugars other than ribose.

As used herein, the term “pairing” in reference to nucleotides or nucleic acid strands refers to interaction between nucleotides or nucleic acid strands by the formation of hydrogen bonds. Pairing comprises thermodynamically favorable “Watson-Crick” pairs (i.e., G-C and A-T pairs in DNA and G-C and A-U pairs in RNA). Pairing also comprises non Watson Crick “mismatch” pairs. G-T pairs in DNA and G-U pairs in RNA, referred to as “wobble pairs”, are stable mismatches. Other mismatches include but are not limited to: G-G, G-A, A-A, T-T, C-C, C-T, A-C (in approximate decreasing order in stability in DNA (Peyret, N., Seneviratne, P. A., Allawi, H. T. & SantaLucia, J., Jr. (1999), “Nearest-Neighbor Thermodynamics and NMR of DNA Sequences with Internal A-A, C-C, G-G, and T-T Mismatches”, Biochemistry 38, 3468-3477). A similar order applies to RNA, with U replacing T. Pairing also comprises natural base:analog pairs and analog-analog pairs.

As used herein, the term “primary structure” refers to the sequential order of units in a strand or chain. As used in reference to nucleic acids, the primary structure is the sequence of nucleotides in the nucleic acid strand. As used in reference to a protein, the primary structure refers to the sequence of amino acids in the chain.

As used herein, the term “secondary structure” refers to the representation of the pairing interactions between nucleotides, including pairing in pseudoknots. Secondary structure may be represented in a number of ways. For example, it may be represented in two dimensions, e.g., on a Nussinov circle plot, in which a nucleotide sequence is mapped on a circle and pairing interactions are denoted by chords, or it may be drawn with the paired nucleotides close to one another (e.g., as shown after Step 2 in FIG. 2, for a tRNA). Secondary structure may also be represented in three dimensions, e.g., as in a functional 3D structure of a nucleic acid in which the pairs adopt the A-form or B-form helical structures, but the loop nucleotides are partially disordered (e.g., populated according to a Boltzmann distribution), and the relative orientations of helices with respect to one another is not specified exactly. The 3D representation is used when referring to the hierarchal folding process of nucleic acids.

As used herein, the term “pseudoknot” refers to any structure wherein, when mapped on Nussinov circle plot, there is crossing of the chords that denote pairing interactions.

Reference is made to different lengths of nucleic acids, e.g., they may be characterized as large or long, medium, and small or short. As used herein, “small” or “short” means less than 25 nucleotides in length; “medium” means 25 to 100 nucleotides in length, and “large” or “long” means greater than 100 nucleotides in length.

As used herein, the term “constraint” refers to an aspect of a structure that might otherwise be variable, but that is assigned a particular value (e.g., a property, position or relationship) during modeling of a structure. Constraints may comprise experimental or theoretically derived aspects of a structure, including but not limited to: distances between components of a structure, (e.g., from NMR NOE measurements or FRET measurements); dihedral angles (e.g., from NMR J-coupling measurements); directions with respect to an axis (e.g., from NMR residual dipolar coupling measurements); exposure of a component to the surface of a structure (as determined by, e.g., EDTA-Fe probing), exposure to solvent (as determined by, e.g., reaction with DMS, DEPC, ENU, CMCT or kethoxal reagents); positions of phosphorus atoms, positions of nucleotides (as determined by, e.g., low resolution X-ray crystallography, cryo-electron microscopy, atomic force microscopy, or NMR methods); other aspects of nucleotide disposition in a structure (e.g., proximity to other nucleotides, paired or unpaired status, or pairing with a particular other nucleotide) such as can be determined by, for example, cross-linking [e.g., using psoralin or mustard reagents) or nuclease sensitivity (e.g., Nucleases S1 and V1, or structure-specific nucleases such as FENs).

As used herein, the terms “processor” and “central processing unit” or “CPU” are used interchangeably and refer to a device that is able to read a program from a computer memory (e.g., ROM or other computer memory) and perform a set of steps according to the program.

As used herein, the terms “computer memory” and “computer memory device” refer to any storage media readable by a computer processor. Examples of computer memory include, but are not limited to, RAM, ROM, computer chips, digital video discs (DVD), compact discs (CDs), hard disk drives (HDD), and magnetic tape.

As used herein, the term “computer readable medium” refers to any device or system for storing and providing information (e.g., data and instructions) to a computer processor. Examples of computer readable media include, but are not limited to, DVDs, CDs, hard disk drives, magnetic tape and servers for streaming media over networks.

As used herein, the term “encode” refers to the process of converting one type of information or signal into a different type of information or signal to, for example, facilitate the transmission and/or interpretability of the information or signal. For example, image files can be converted into (i.e., encoded into) electrical or digital information. Likewise, light patterns can be converted into electrical or digital information that provides and encoded video capture of the light patterns.

As used herein, the term “hyperlink” refers to a navigational link from one document to another, or from one portion (or component) of a document to another. Typically, a hyperlink is displayed as a highlighted word or phrase that can be selected by clicking on it using a mouse to jump to the associated document or documented portion.

As used herein, the term “Internet” refers to any collection of networks using standard protocols. For example, the term includes a collection of interconnected (public and/or private) networks that are linked together by a set of standard protocols (such as TCP/IP, HTTP, and FTP) to form a global, distributed network. While this term is intended to refer to what is now commonly known as the Internet, it is also intended to encompass variations that may be made in the future, including changes and additions to existing standard protocols or integration with other media (e.g., television, radio, etc). The term is also intended to encompass non-public networks such as private (e.g., corporate) Intranets.

As used herein, the terms “World Wide Web” or “web” refer generally to both (i) a distributed collection of interlinked, user-viewable hypertext documents (commonly referred to as Web documents or Web pages) that are accessible via the Internet, and (ii) the client and server software components which provide user access to such documents using standardized Internet protocols. Currently, the primary standard protocol for allowing applications to locate and acquire Web documents is HTTP, and the Web pages are encoded using HTML. However, the terms “Web” and “World Wide Web” are intended to encompass future markup languages and transport protocols that may be used in place of (or in addition to) HTML and HTTP.

As used herein, the term “web site” refers to a computer system that serves informational content over a network using the standard protocols of the World Wide Web. Typically, a Web site corresponds to a particular Internet domain name and includes the content associated with a particular organization. As used herein, the term is generally intended to encompass both (i) the hardware/software server components that serve the informational content over the network, and (ii) the “back end” hardware/software components, including any non-standard or specialized components, that interact with the server components to perform services for Web site users.

As used herein, the term “HTML” refers to HyperText Markup Language that is a standard coding convention and set of codes for attaching presentation and linking attributes to informational content within documents. During a document authoring stage, the HTML codes (referred to as “tags”) are embedded within the informational content of the document. When the Web document (or HTML document) is subsequently transferred from a Web server to a browser, the codes are interpreted by the browser and used to parse and display the document. Additionally, in specifying how the Web browser is to display the document, HTML tags can be used to create links to other Web documents (commonly referred to as “hyperlinks”).

As used herein, the term “HTTP” refers to HyperText Transport Protocol that is the standard World Wide Web client-server protocol used for the exchange of information (such as HTML documents, and client requests for such documents) between a browser and a Web server. HTTP includes a number of different types of messages that can be sent from the client to the server to request different types of server actions. For example, a “GET” message, which has the format GET, causes the server to return the document or file located at the specified URL.

As used herein, the term “URL” refers to Uniform Resource Locator that is a unique address that fully specifies the location of a file or other resource on the Internet. The general format of a URL is protocol://machine address:port/path/filename. The port specification is optional, and if none is entered by the user, the browser defaults to the standard port for whatever service is specified as the protocol. For example, if HTTP is specified as the protocol, the browser will use the HTTP default port of 80.

As used herein, the term “PUSH technology” refers to an information dissemination technology used to send data to users over a network. In contrast to the World Wide Web (a “pull” technology), in which the client browser must request a Web page before it is sent, PUSH protocols send the informational content to the user computer automatically, typically based on information pre-specified by the user.

As used herein, the term “in electronic communication” refers to electrical devices (e.g., computers, processors, NMR devices, fluorescent readers, etc.) that are configured to communicate with one another through direct or indirect signaling. For example, a conference bridge that is connected to a processor through a cable or wire, such that information can pass between the conference bridge and the processor, are in electronic communication with one another. Likewise, a computer configured to transmit (e.g., through cables, wires, infrared signals, telephone lines, etc) information to another computer or device, is in electronic communication with the other computer or device.

As used herein, the term “transmitting” refers to the movement of information (e.g., data) from one location to another (e.g., from one device to another) using any suitable means.

### DESCRIPTION OF DRAWINGS

FIG. 1 provides an overview of forward and reverse folding of nucleic acids, through primary (1°), secondary (2°), and tertiary (3°) or 3D structures.

FIG. 2 provides a diagram showing the steps of the RNA folding problem. The first step involves prediction of secondary structure from the sequence, which may be accomplished using thermodynamic energy minimization using a dynamic programming algorithm or by comparative sequence analysis using evolutionary principles. The second step involves prediction of tertiary structure based on the secondary structure. The “big O” dependence of the number of structures for a sequence of length N is given.

FIG. 3 shows one embodiment of a Graphical User Interface (GUI) for Homology Modeling. The interface allows the user to Input a .pdb coordinate file and to load a sequence alignment (in the future the SBSA will be performed automatically). The “Add hydrogens” check box automatically analyzes the coordinate file and adds hydrogens so that the predicted output .pdb file is ready for use in AMBER. Clicking the “Substitute Bases” button results in the automatic insertion, deletion, and substitution of residues as dictated by the sequence alignment and automatically performs the DSTA optimization. The RMSD button allows the user to compare the predicted .pdb file to the experimental .pdb file, if available.

FIG. 4 provides a summary of certain preferred embodiments of the systems and methods of the present invention in the form of a flowchart of a NA_HOMOLOGY algorithm.

FIG. 5 shows one embodiment of a graphical user interface for the RMSD calculations (left panel) and the graphical output (right panel) for “Global per residue RMSD” and “Local per residue RMSD”. The results shown are for the homology modeled 5S rRNA of D. radiodurans using H. marismortui as the reference template without closing of gaps and overlaps. The results show certain residues are in poor geometries (Local RMSD>1.5 Å) and also certain residues that are in good geometries but are not placed correctly due to rotation and translation of a whole helix (Global RMSD>6 Å).

FIG. 6 provides a summary of certain preferred embodiments of the systems and methods of the present invention, in the form of a flow diagram of a De novo Structure prediction algorithm.

FIG. 7 provides a summary of certain preferred embodiments of the systems and methods of the present invention in the form of a flow diagram of a BUILDER algorithm.

FIG. 8 illustrates one embodiment of “structure morphing”. The hairpin on the left is the 690 loop of 16S rRNA, while the hairpin on the right is the tRNAphe anticodon loop.

FIG. 9 shows results of structure morphing in which the 8 nt. 690 loop is morphed into the 7 nt. Anticodon loop using the homology modeling algorithm (left panel with the deletion gap of 7.42 Å). The middle panel shows the result after DSTA algorithm (RMSD=1.46 Å). The left panel shows the X-ray structure (PDB: 1EHZ).

FIG. 10 shows results of structure morphing as a result of an insertion overlap (left panel). The AMBER optimization completely failed (not shown). The DSTA algorithm resolved the overlap and gives an RMSD of 1.35 Å (middle panel) compared to the NMR structure (right panel).

FIG. 11 provides an example entry in a MOTIF database used by BUILDER. For brevity, coordinates are only shown for the first residue. The backbone only is given and the base is attached at the time BUILDER adds the motif using the chi dihedral, bond length, and bond angle information.

FIG. 12 provides a summary of certain preferred embodiments of the systems and methods of the present invention in the form of a flow diagram for a MOTIF algorithm.

FIG. 13 shows Table 1, which provides an example of the organization of data within a database of the present invention.

FIG. 14 provides a structure alignment by SBSA for the 5S rRNA of H. marismortui (1JJ2) and D. radiodurans (1NKW). Note that CLUSTAL-W correctly aligns only 77.5% of the residues, while SBSA gets 100% correct. The code above and below sequence is as follows: i=insertion, d=deletion, L=nucleotide that is paired to its 3′-side, R=nucleotide that is paired to its 5′-side, m=nucleotide that forms a mismatch that is known from phylogeny to be often replaced by base pairs. “Struc. Indent.” means that the nucleotides are in identical locations in the secondary structures.

FIG. 15 provides diagrams of secondary structures of the 55 rRNA sequences that are aligned in FIG. 13. The positions of insertions and deletions are shown. The secondary structures were derived by comparative sequence analysis (Gutell, R. R. (1994) Nucleic Acids Res. 22, 3502-7) and the figures generated using Visual OMP (DNA Software, Inc.). Insertion and deletion sites found in the SBSA from FIG. 13 are indicted.

FIG. 16 diagrams RESP charges for adenosine (left) and pseudouridine (right). The charges for adenosine found in the AMBER file all_nuc94.in are shown in parentheses70. Similarly, the contributed parameters for pseudouridine at the AMBER website (at pharmacy.man.ac.uk/amber/nuc/tRNA.lib) are shown in parentheses.

FIG. 17 provides diagrams of tRNA backbone structures. Left panel is the backbone of the x-ray structure of the human tRNAlys (PDB: 1FIR) with chemical modifications removed. Right panel is the predicted structure of human tRNAlys obtained by threading the human tRNAlys sequence into the yeast tRNAphe structure (PDB: 1EHZ) without AMBER refinement. The all-atom RMSD for the experimental vs. predicted structures is 2.4 Å (2.0 Å RMSD for residues 1-73). The sequences of human tRNAlys and yeast tRNAphe are 63% identical with no insertions or deletions.

FIG. 18 provides diagrams of tRNA backbone structures. The left panel is the backbone of the x-ray structure of the human tRNAlys (PDB: 1FIR) with modifications removed. The right panel is the de novo method of three-dimensional structure prediction without AMBER optimization of human tRNAlys given the correct secondary structure, but no other information. The all atom RMSD compared to the experimental structure (c.f. FIG. 17 left panel) is 3.8 Å. For clarity, only the backbone phosphorus atoms are shown. Note that before building this structure, the loops from 1EHZ (tRNAphe) were removed from the motif database (see Table 1, FIG. 13) to prevent bias in the structure prediction.

FIG. 19 provides a summary of certain preferred embodiments of the systems and methods in the form of a flow diagram of a BP_GEOM algorithm

### GENERAL DESCRIPTION OF THE INVENTION

Two approaches have commonly been applied to elucidate nucleic acid secondary structures: physical approaches, such as analysis of crystal structure or NMR, and analytical approaches, such as comparative or phylogenetic analysis. Physical analysis remains the only way to get a complete determination of a folded structure for any given nucleic acid. However, that level of analysis is impractical if the goal is to analyze a large number of molecules. By far, the most often used method of analyzing biological nucleic acids is a phylogenetic, or comparative approach. This method of analysis is based on the biological paradigm that functionally homologous sequences will adopt similar structures. Sequences are screened for sequence conservation, stem-loop conservation, and for compensatory sequence changes that preserve predicted structures. Unfortunately, such analysis can only be applied when the number of related sequences is large enough for statistical analysis.

Methods for macromolecular structure determination (NMR, X-ray crystallography, cryo-electron microscopy, and atomic force microscopy) are labor and time intensive, and thus cannot keep pace with the exponential growth of naturally occurring sequence databases (e.g. GENBANK) or with synthetic sequences such as aptamers or rationally (by humans or by computers) designed sequences.

Thus, there is a need to develop tools for structure prediction from sequence. The systems and methods of the present invention provide means for accurately predicting nucleic acid structure (including, but not limited to, DNA, RNA, natural modifications, synthetic modifications and nucleic acid analogs) from sequence and constraint information. The systems and methods of the present invention find application in rational drug design (e.g., design or selection of antibiotics against pathogen ribosomes, anticancer therapeutics targeted to telomerase, spliceosomes, and other RNA processing enzymes that are more active in cancerous cells than normal cells). In addition, the systems and methods of the present invention find application to the in silico design of nucleic acid-based structured nano-materials (Seeman, N.C. (1998). DNA Nanotechnology: Novel DNA Constructions. Annu Rev. Biophys. Biomol. Struct. 27, 225-248), nano-robots or nano-machines (Turberfield, A. J., et al., (2003) Physical Review Letters 90, 118102-1-118102-4; Benenson, Y., et al., (2003) Proc Natl Acad Sci USA 100, 2191-6), and computing (Adelman, L. M. (1994) Science 266, 1021-1024).

Progress has been made on the “protein folding problem” in the past 30 years (Bourne, P. E. (2003) CASP and CAFASP experiments and their findings, In Structural Bioinformatics (Bourne, P. E. & Weissig, H., eds.), pp. 501-7, Wiley-Liss, Inc., Hoboken; Krieger, E., et al., (2003) Homology modeling. In Structural Bioinformatics (Bourne, P. E. & Weissig, H., eds.), pp. 509-23, Wiley-Liss, Inc., Hoboken; Chivian, D., et al., (2003). Ab initio methods. In Structural Bioinformatics (Bourne, P. E. & Weissig, H., eds.), pp. 547-57, Wiley-Liss, Inc., Hoboken. Nonetheless, it is still very challenging to accurately predict protein structure from sequence information alone and rational protein design is still in its infancy. In contrast, relatively little progress has been made on the RNA and DNA folding problems. The current state of the art for RNA and DNA secondary structure prediction is approximately 73%, and 85%, respectively (Mathews, D. H., et al., (1999). J Mol Biol 288, 911-40) and very little software is available for predicting DNA and RNA tertiary structure (Gautheret, D., et al., (1993). J. Mol. Biol. 229, 1049-1064).

Several groups have anticipated that prediction of RNA secondary structure may be considerably easier than the protein folding problem (Tinoco, I., Jr. & Bustamante, C. (1999) J. Mol. Biol. 293, 271-281; Turner, D. H., et al., (1988) Annu Rev. Biophys. Biophys. Chem. 17, 167-192), but general software for highly accurate automated 3D structure prediction of large, medium and small nucleic acids has not been reported in the literature. RNA has only 4 different residues all of which contain a heterocyclic aromatic base, while proteins have 20 different amino acids with diverse chemical functionality (apolar, charged, sulfhydryl, aromatic, etc.). In addition, RNA has strong pairing rules (G-C and A-U), while there are no such rules for proteins. These strong pairing rules result in well-defined secondary structure and domain boundaries that are readily predicted by comparative sequence analysis even when the sequence homology is low (which is not the case for proteins). Unfortunately, for an RNA of length N, there are approximately 1.8^{N} possible structures (M. Zuker & D. Sankoff. RNA Secondary Structures and their Prediction. Bull. Mathematical Biology 46, 591-621 (1984)); this makes the search for the global optimum impossible to determine for N>50. Fortunately, the discrete nature of base pairing also makes RNA folding accessible to dynamic programming algorithms, which are very efficient—the global minimum is guaranteed to be found, along with structures near the optimum, with calculation time proportional to N³, which is tractable for N<10,000 with routinely available computers (Zuker, M. (1989) Science 244, 48-52). The main drawback of using dynamic programming algorithms, however, is that RNA is represented as letters rather than three-dimensional atomic structures, which means that the folding rules are only approximate and incomplete, and they neglect “pseudoknot structures” (Pleij, C. W. (1995). Structure and function of RNA pseudoknots. Genet Eng (N Y) 17, 67-80). In contrast, classical molecular dynamics simulations (such as AMBER and CHARMM) provide an essentially complete atomic description and thus they are able to correctly converge on the correct structure, but only if started with a structure sufficiently close to the global optimum. The classical molecular dynamics simulations are not capable of widely searching conformation space, however.

The systems and methods of the present invention combine the strengths of dynamic programming algorithms and classical molecular dynamics simulations with novel algorithms for homology modeling, sequence alignment, nucleic acid geometrical manipulations, novel hybrid forcefield, and novel structural motif databases. In combination, the systems and methods of the present invention allow accurate prediction of nucleic acid structure from primary sequence information and constraint information.

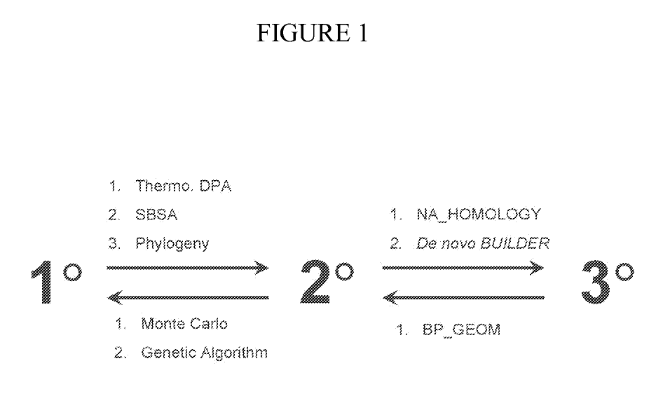

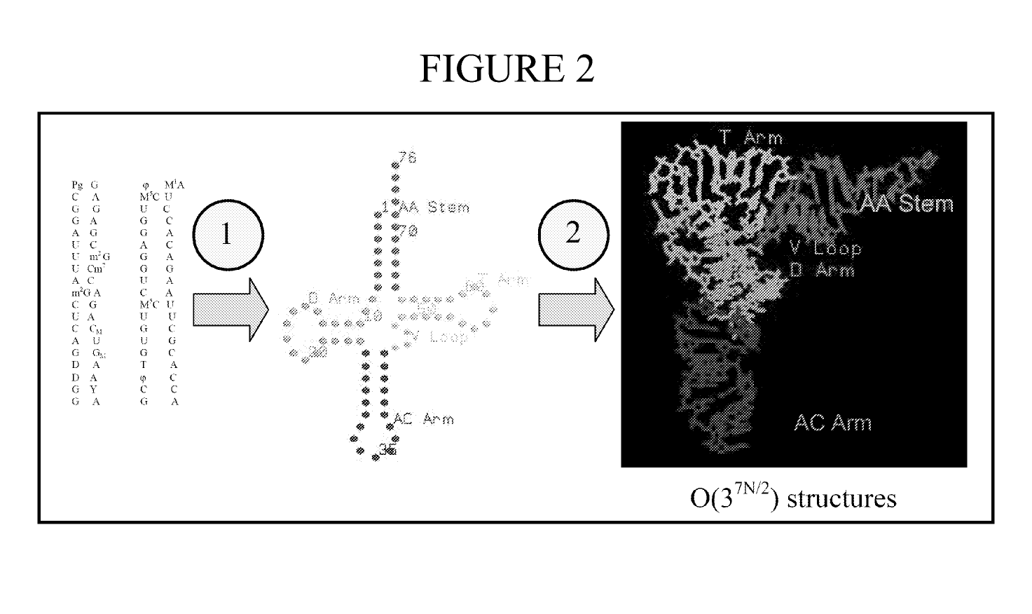

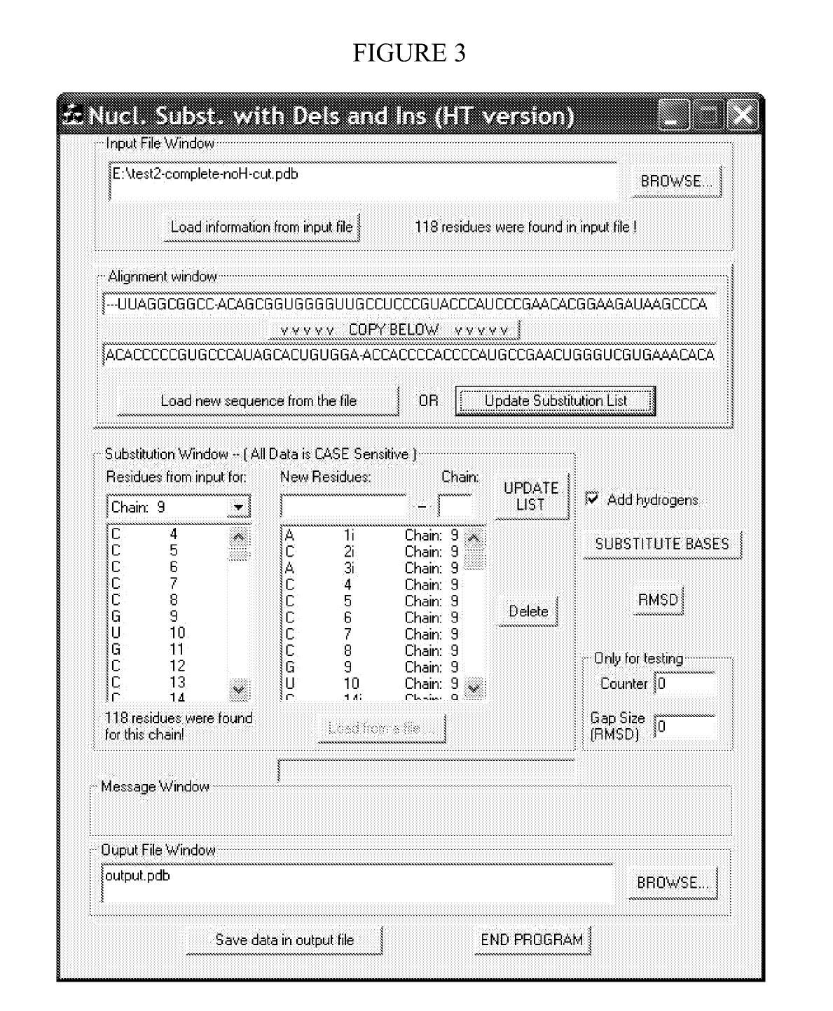

A general overview of the forward and backward prediction methods of the present invention is summarized in FIG. 1.

### DETAILED DESCRIPTION OF THE INVENTION

The systems and methods of the present invention combine the strengths of dynamic programming algorithms and classical molecular dynamics simulations with new methods for homology modeling, sequence alignment, nucleic acid geometrical manipulations, hybrid forcefield, and novel structural motif databases. These combinations provide new tools for the accurate prediction of nucleic acid structure from sequence and constraint information.

This Detailed Description of the Invention comprises the following sections: I: Homology modeling of nucleic acids; II: De novo 3D structure prediction of nucleic acids; III. Nucleic acid motif database; IV: An advanced forcefield for nucleic acids; V. Structure Based Sequence Alignment and Threading of Nucleic Acids; VI: Identification of Conserved Hydrogen bonds; VII: Systems of the Present Invention. These descriptions are illustrations of certain preferred embodiments of the present invention are not intended to limit the scope thereof.

### I. Homology Modeling of Nucleic Acids.

For many functional RNAs (tRNA, rRNAs, ribozymes, etc.), the secondary structure may be accurately deduced by comparative sequence analysis (Gutell, R. R., et al., (1992) Nucleic Acids Res 20, 5785-95), where at least one X-ray crystal or NMR structure representative of the class is available (referred to as the “reference template”). The NA_HOMOLOGY algorithm of the present invention “threads” a sequence whose three-dimensional structure is entirely or partially unknown (referred to as the “query sequence” or “test sequence”) into the reference template coordinates. The first step performs a novel sequence alignment between the template and query sequences subject to secondary structure constraints present in the template structure. This is called “structure based sequence alignment” (described in more detail below in Section V). The second step of the threading algorithm is to make the substitutions, deletions and insertions dictated by the sequence alignment using geometrical computations for the substitutions and using modified classical molecular mechanics and molecular dynamics to close the gaps caused by deletions and insertions (described in more detail below in Section III). Insertions may also be accomplished using the BUILDER algorithm (described in more detail below in Section II). In the preferred embodiment, each motif with an insertion and deletion would be modeled by NA_HOMOLOGY using DSTA optimization and also by BUILDER using all candidate motif structures in the database and choosing the motif from all methods that has the best folding energy. The third step is to identify conserved hydrogen bonds (H-bonds) present in both the reference template and the initial homology model of the unknown sequence (described in more detail below in Section VI). The fourth step is to optimize the structure using classical forcefield methods (described in more detail below in Section IV) subject to the conserved H-bond constraints. This methodology has tremendous potential to, among other uses, leverage the genome sequencing projects by allowing the automated conversion of a large percentage of the functional RNAs in sequence databases into 3D structural model databases.

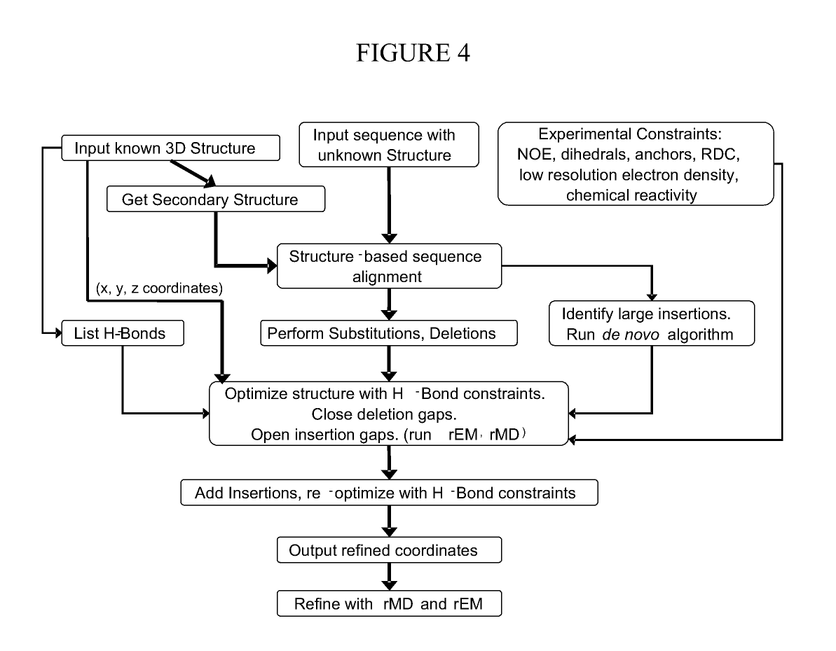

A summary of certain preferred embodiments of the systems and methods are shown in FIG. 4.

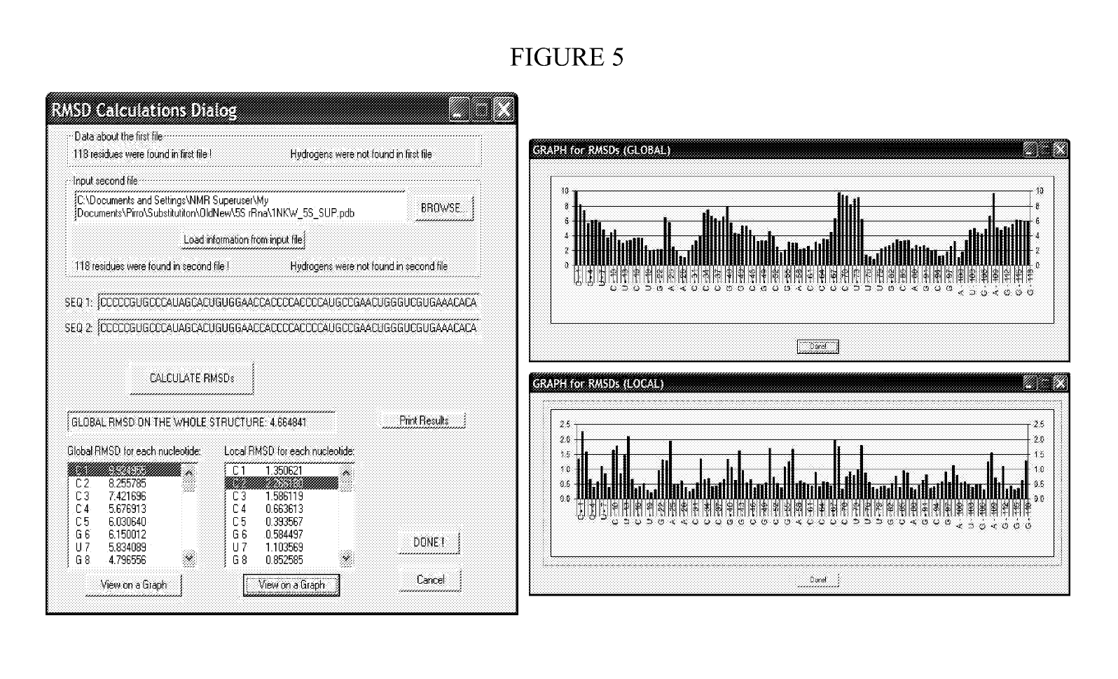

Root mean squared deviation calculation (RMSD) is one method of comparing structures. One embodiment of a graphical user interface for the RMSD calculations (left panel) and the graphical output (right panel) for “Global per residue RMSD” and “Local per residue RMSD” is shown in FIG. 5. The diagnostic software of the present invention evaluates dihedral angles, bond lengths, bond angles, and stereochemistry, and has proven to be quite useful for identifying anomolies in the gap closing and BUILDER algorithms. The systems and methods of the present invention provide code for superimposing two structures with the same number of atoms using the quaternion algebra method of Kearsley (Kearsley, S. K. (1989) Acta Cryst A45, 208-10). The RMSD algorithm is used to determine the optimal placement of base pairs and loop motifs in the BUILDER algorithm. In one embodiment, the code computes profiles called “Global per residue RMSD” and “Local per residue RMSD” (FIG. 5). The Global per residue RMSD is computed by superimposing the two complete structures and then calculating the RMSD for each residue without changing the rotation of the two molecules. For the Local RMSD each nucleotide is individually superimposed neglecting the rest of the molecule. The two plots of RMSD vs. residue number (FIG. 5) show that, in some cases, a given residue can have a small Local RMSD but a large Global RMSD due to large scale translation or rotation of a fragment of the total structure. Residues that have poor local RMSDs are generally in the wrong conformation, and are easy to identify even in large structures by this method. RMSDs involving only the phosphorus atoms are also computed, providing a measure of the correctness of the global fold of RNA that is similar to the Cα chain RMSD commonly used for such purposes for proteins. The systems and methods of the present invention also provide algorithms that automatically calculate the total inter-residue forcefield interaction energy for each residue in the molecule. This quickly identifies residues that have close steric contacts, poor electrostatics, or lack favorable interactions.

### II. Method and Systems for Three-Dimensional (E.G., De Novo) Structure Prediction of Nucleic Acids

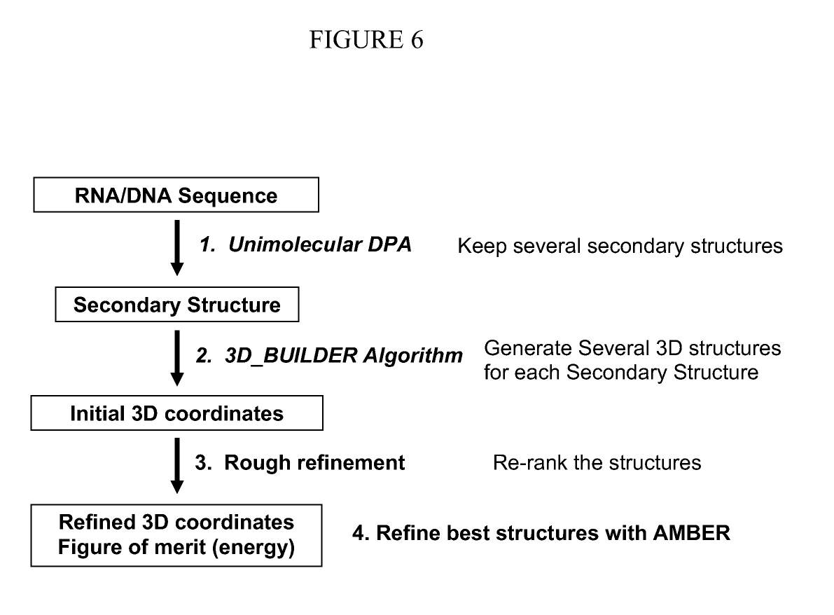

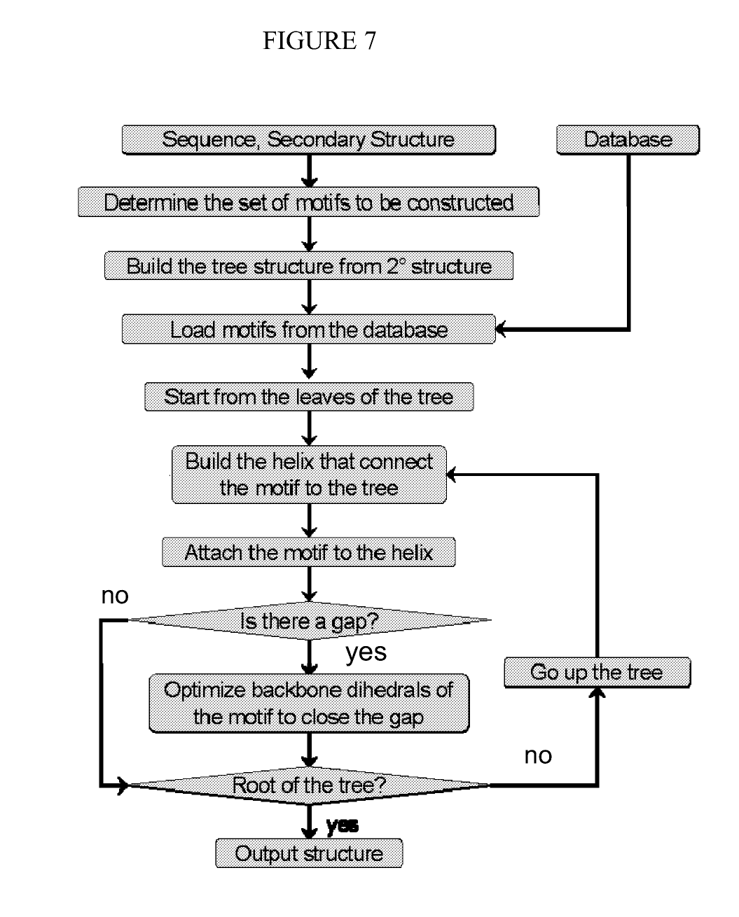

Application of dynamic programming algorithms (DPA) for prediction of optimal and suboptimal secondary structures of RNA is well established in the literature (Zuker, M. (1989) Science 244, 48-52). A thermodynamic DPA called Visual OMP (Oligonucleotide Modeling Platform) based on patent pending application number WO0194611 A2 WO (herein incorporated by reference in its entirety) can be used in the systems and methods of the present invention to compute optimal and suboptimal secondary structures of DNA and RNA and other modified nucleic acids. The BUILDER algorithm of the present invention converts each of the optimal and suboptimal secondary structures into several three-dimensional structures using an embedding algorithm. The BUILDER algorithm works in four steps: 1) the predicted secondary structure is decomposed into its constituent motifs (e.g., base pairs, hairpins, bulges, internal loops, etc.) and used to generate a hierarchal tree (e.g., with hairpins as the leaves, internal loops, bulges as the branches, and multiloops and bifurcations as sub-roots and roots, respectively); 2) candidate 3D structures for each motif are retrieved from a novel motif database (see Section III); 3) the motifs are geometrically linked together in the order specified by the tree; and 4) classical molecular dynamics simulations and energy minimization using the forcefield (NA_FF; Section IV below) as well as AMBER or CHARMM or similar techniques used to refine the structures. If the secondary structure is known already from phylogeny (e.g., comparative sequence analysis) or by experimental methods (e.g., site directed mutagenesis, chemical probing, nuclease probing etc.), then the BUILDER algorithm can start with the correct secondary structure. The candidate structures are then be re-ranked according to a total energy that is a weighted sum of the minimized forcefield energy and secondary structure folding energy from the dynamic programming algorithm (Visual OMP). The result is highly accurate three-dimensional de novo structure predictions of RNA, DNA, and modified nucleic acids or other biomolecules. Importantly, this approach is completely general and applies even to RNA and DNA sequences for which there are no available representative three-dimensional structures, which is tremendously useful for elucidating the structures of new functional RNAs discovered in genome projects or in vitro aptamer screens. This approach is also useful for in silico design of new RNA and DNA folds that do not exist in nature, but that have novel materials, catalytic, or nanotechnology applications. A summary of certain preferred embodiments of the systems and methods are shown in FIGS. 4 and 6.

The simplest implementation of BUILDER only tests candidates for each individual motif independently of other motifs in the structure. A better approach is to build several whole structures with different combinations of models for all of the loops, thereby accounting for interactions among loops. If the RNA is small and contains only a few loops, then all possible combinations of motifs are assembled. For example, the secondary structure of tRNA, which contains 3 hairpins and one multi-loop, has a total of 4 motifs. If 3 candidate structures are kept for each motif, then the total number of structures to consider is 3⁴=81 different combinations. This is computationally tractable for a single CPU, given the efficiency of NA_FF. If the RNA is large, then the number of combinations would preclude an exhaustive computation of all combinations of motifs and a sampling algorithm (e.g., Monte Carlo) or iterative search method (e.g., Genetic Algorithm) are used in conjunction with NA_FF to score and optimize the candidate structures. For large RNA molecules like group II introns and RNaseP, a LINUX cluster or super computer may be needed. One way to reduce the search space is to identify the subset of motifs that are close enough to interact (e.g., the two motifs have atoms that are within some cutoff distance like 5 Å), and to only search those subsets for combinations of the candidate structures.

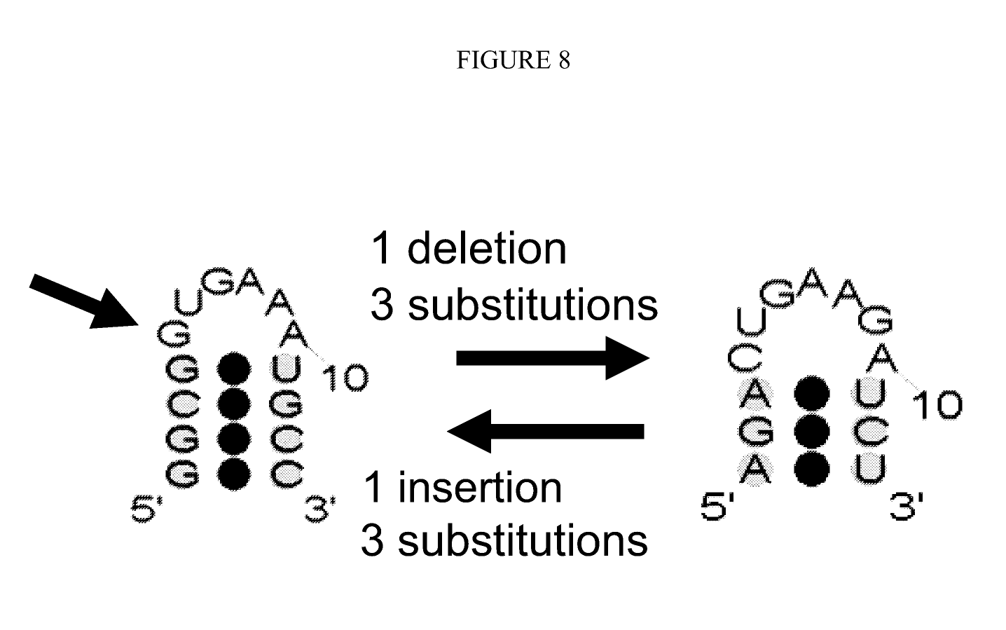

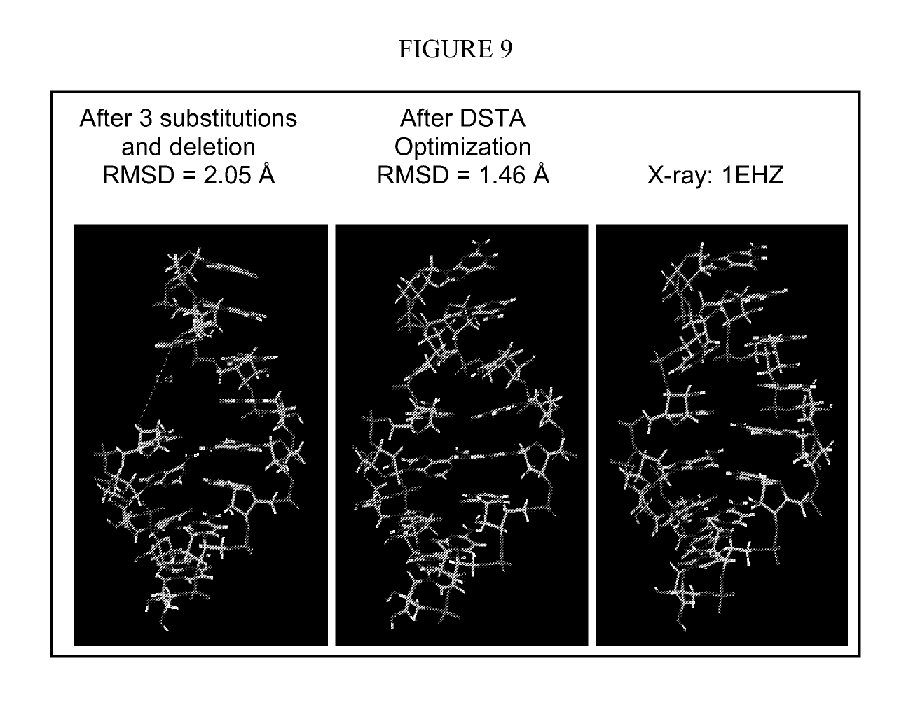

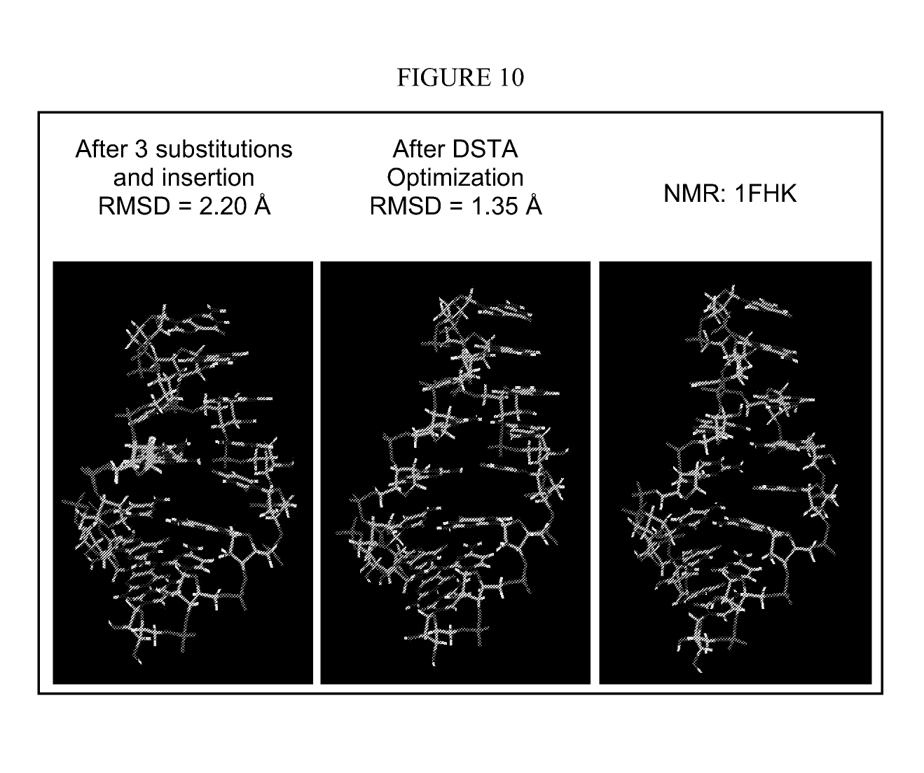

For deletions, a refinement algorithm that performs discrete sampling of torsion angles with rigid body rotations (DSTA) is applied (described in more detail in Section IV, below). This algorithm closes deletion gaps and generally works for “conservative” insertions (i.e., insertions that don't change the structure dramatically). The DSTA algorithm is demonstrated by conversion an 8 nt. hairpin (the 690 loop of 16S rRNA) to a 7 nt. hairpin (the tRNAphe anticodon loop) as shown in FIG. 8. Such structure conversion is termed “structure morphing” and it can be applied to loops that are structurally similar, even if not necessarily evolutionarily related). FIG. 9 shows the results of the forward direction, in which the homology modeling algorithm creates a gap (left panel) as a result of the deletion required to make the anticodon loop. The right panel shows the result of the DSTA algorithm which has an RMSD of 1.46 Å with the crystal structure 1EHZ. Note that the major discrepancy in the modeled structure is the closing A-U pair, which is predicted to form a standard Watson-Crick geometry, while the crystal structure shows a “sheared” type geometry due to a crystal packing artifact. Thus the modeled structure may actually be a better representation of the solution structure than that observed crystallographically. FIG. 10 shows the results of the reverse direction, in which the homology-modeling algorithm creates an overlap (left panel) as a result of the insertion required to make the 690 loop. The AMBER MD simulation failed to start properly due to the overlapping atoms (not shown). The DSTA algorithm optimized the insertion and has an RMSD of 1.35 Å with the NMR structure (PDB: 1FHK) (Morosyuk, S. V., Cunningham, P. R. & SantaLucia, J., Jr. (2001) J. Mol. Biol., 197-211).

### III. Nucleic Acid Motif Database.

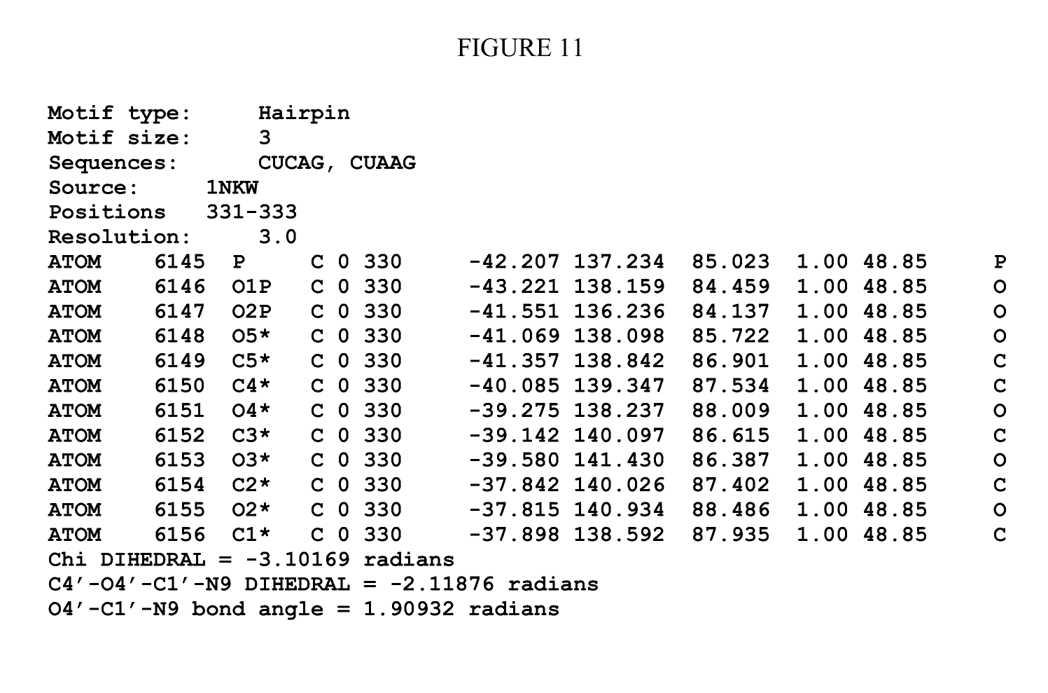

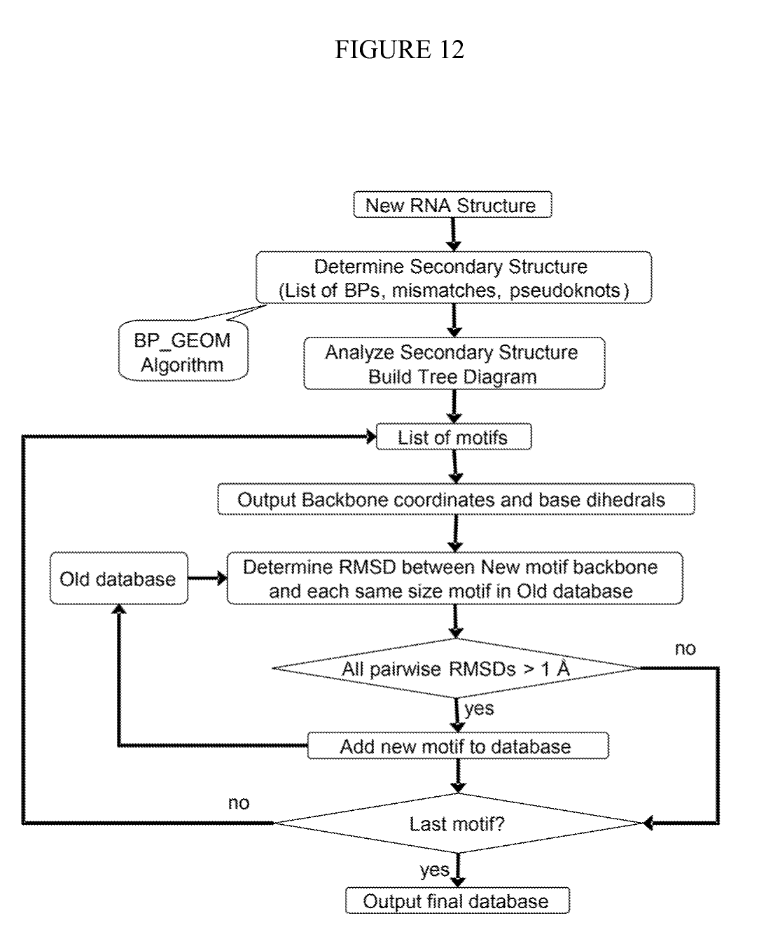

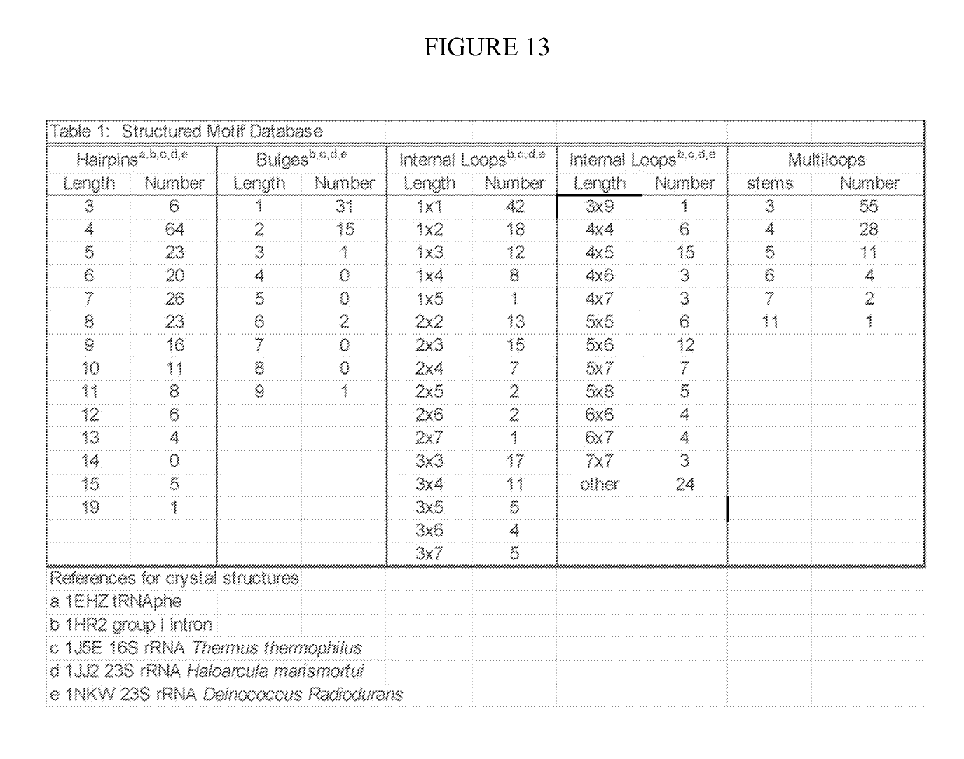

The flowchart describing the construction of a motif database is given in FIG. 12. The database has been embodied in a flat file format and can be readily adapted to a relational database (an example entry is shown in FIG. 11). In preferred embodiments, each entry in the database contains the keywords that describe the type of motif, size of the motif, source of the coordinates (e.g. PDB accession number), resolution/reliability parameter, sequences known to form the motif, and xyz coordinates of the backbone (ribose-phosphate for RNA, deoxyribose-phosphate for DNA, or modified backbone for modified nucleic acids), and dihedral angles for the base moiety of each of the nucleotides. Each motif contains the closing base pair (for hairpins) or base pairs (for internal loops, bulges, and multiloops), so that it may be readily appended to the next base pair in a stem. The coordinates in the database are derived from NMR and X-ray structures of larger DNAs and RNAs and modified nucleic acids that are found in the Protein Database (PDB). As new structures are added to the PDB, an algorithm called MOTIF automatically decomposes the structure into its motifs and compares the new motifs to those existing in the database to determine the root mean squared deviation (RMSD) with the existing motifs to determine if the new motif is unique (FIG. 12). If the motif is not unique, the sequence of the motif may still be cataloged under the SEQUENCE keyword, so that it may be used for future sequence alignment searches (e.g., for use in the methods described in Section V). Table 1 in FIG. 13 provides an example of the organization of data within a database of the present invention.

Water molecules and metals may play crucial roles in stabilizing loop structures. The MOTIF algorithm can be configured to examine each water and metal in a PDB structure to determine the loop with which each is associated. These waters and metals may be retained in the MOTIF database. The MOTIF database may also be modified to build in hydrogen atoms and optimize their orientation for each water molecule. Remaining waters may be added to include in the waterbox for AMBER calculations.

The PDB database currently comprises few complex DNA structures. However, DNA structures may be approximated from existing structures in the RNA database using modeling that “morphs” the existing RNA database into a DNA database.

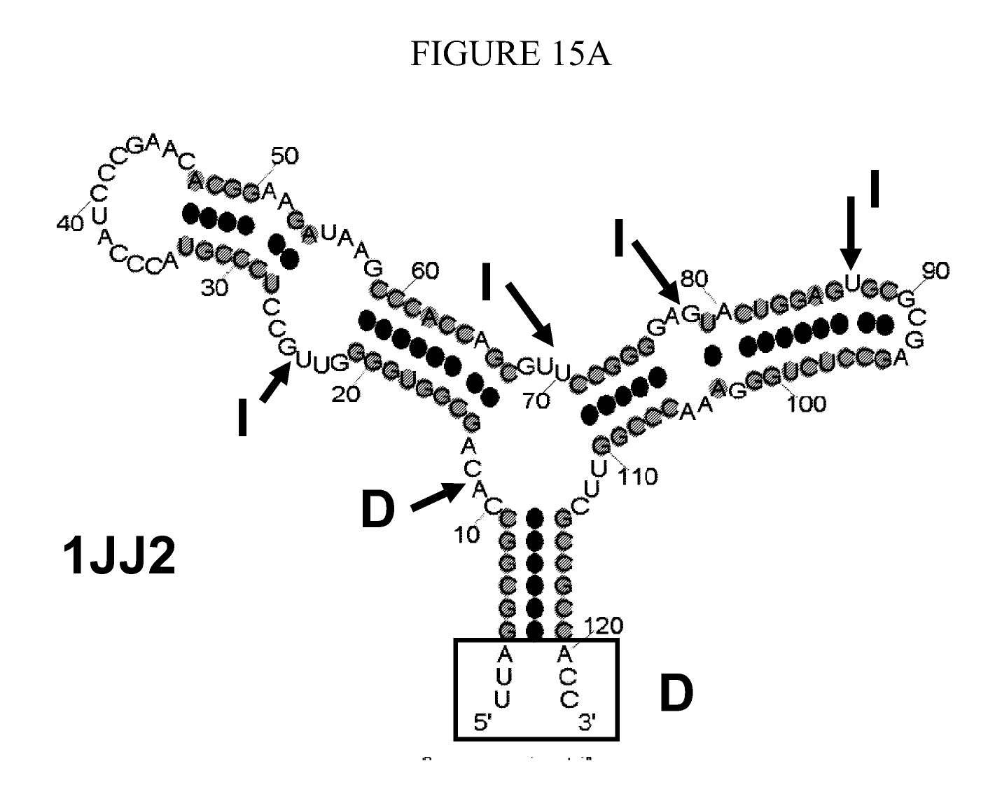

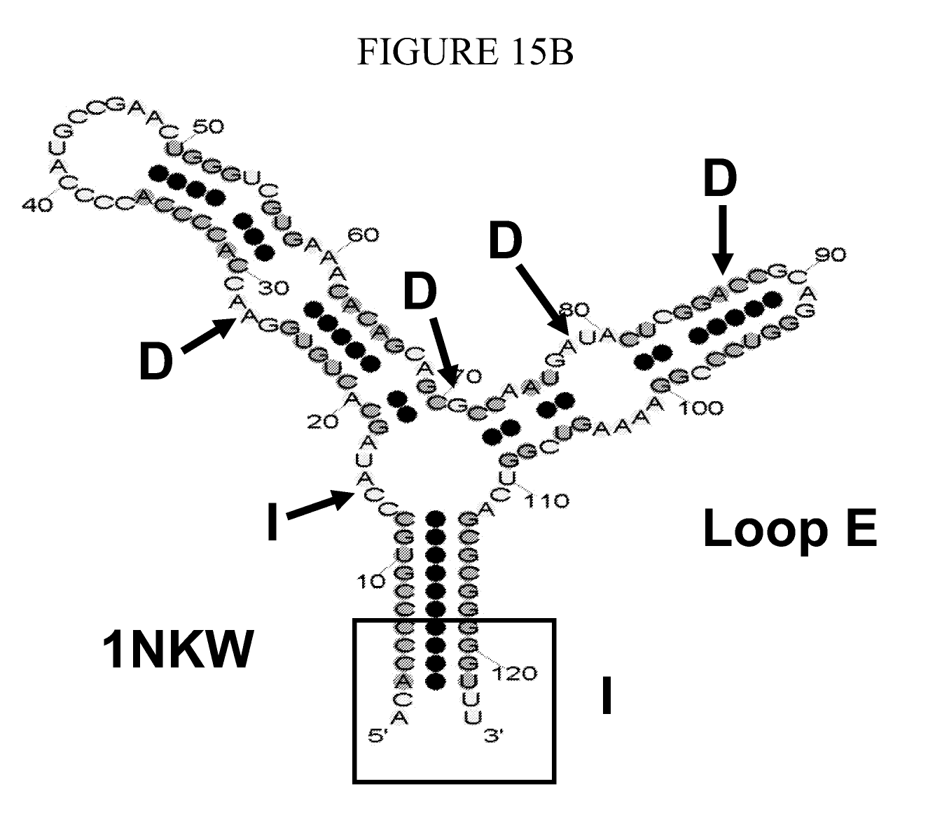

The MOTIF database also provides structural motifs that comprise multiple loops. Whole multi-loop motifs are stored in the MOTIF database similarly to the other loops, wherein phosphoribose backbone and base chi dihedral are stored for all the closing base pairs and single stranded nucleotides in the multiloop. The multi-loops are classified first by the number of stems and then by the number of unpaired residues. For example, in D. radiodurans 5S rRNA (FIG. 15), the central multi-loop has 3 stems and single-stranded regions of lengths 1, 3, and 5 nts. When modeling a new multi-loop, the SBSA algorithm is used to identify the best matches in the database and the DSTA algorithms are used to close gaps and resolve overlaps caused by insertions and deletions. Note that multi-loops are circular and thus N cyclic permutations are possible, where N is the number of stems. For the 1NKW 5S structure there are three permutations of residues 12-18, 70-72, 109-113 that equivalently describe the multi-loop, namely 1. CCCAUG:CGC:GUCAG, 2. GUCAG:CCCAUG:CGC, and 3. CGC:GUCAG:CCCAUG, where colons indicate omission of intervening nucleotides. As described below (Section V) for the SBSA algorithm, the nucleotides that are paired may be masked by the letters “L” and “R” to prevent misalignments. Thus the sequence CCCAUG:CGC:GUCAG becomes LCCAULRGLRUCAR, which is suitable for SBSA.

### IV. An Advanced Forcefield for Nucleic Acids.

The present invention provides a novel forcefield specifically tailored to nucleic acid applications called “NA_FF”. NA_FF includes the traditional terms for classical molecular dynamics and energy minimization including bond stretching, bond angles, torsion stress, and non-bonded interactions (van der Waals, H-bond, electrostatics). The overall form of the NA_FF forcefield is as follows:

$${E}_{total} = {\sum }_{P - O {3}^{′} bonds} {K}_{r} \vert {r}^{2} - {r}_{eq}^{2} \vert + {\sum }_{P - O {3}^{′} angles} {{K}_{θ} ( θ - {θ}_{eq} )}^{2} + {\sum }_{dihedrals} \frac{{V}_{n}}{2} [ 1 + cos ( n φ - γ ) ] + {\sum }_{i < j} [ \frac{{A}_{ij}}{{R}_{ij}^{12}} - \frac{{B}_{ij}}{{R}_{ij}^{6}} + {C}_{ij} ] + {\sum }_{i < j} [ \frac{{D}_{ij}}{{R}_{ij}^{10}} - \frac{{E}_{ij}}{{R}_{ij}^{6}} + {F}_{ij} ] \times ( angle\_terms ) + \frac{{q}_{i} {q}_{j}}{4 * pi * {ɛ}_{o} {R}_{ij}^{2}}$$

Two particular enhancements in the functional form of the forcefield are the equations used for van der Waals repulsion at short distances and the inclusion of a hydrogen bonding term that includes distance, angle, and dihedral terms (described below). Specially optimized force constants, distance dependence, partial charges, and van der Waals radii parameters for nucleic acids are included as well as parameters for several modified nucleotides. NA_FF also includes pseudopotential terms for gap penalties (from insertions and deletions in Sections I and II, above), as well as pseudopotentials for experimental constraints (H-bonds, NOEs, low resolution cryo-electron microscopy or X-ray electron densities, chemical modification data, etc.).

The constraint information is used in a novel “soft constraint” implementation in which distance constraints are imposed as parabolic or Lennard-Jones type function (with 6-12 or other exponents) in the desired distance range, but zero penalty outside the desired range; this implementation allows structures to widely search conformation space without getting stuck in very bad local minima and also accounts for potential inaccuracy in the constraint (i.e., the constraint might be wrong and thus one would not want to apply a penalty for violating the constraint). An additional novel feature of the NA_FF forcefield is the ability to incorporate solution trends in DNA and RNA folding thermodynamics. Traditional forcefield methods do not account for folding entropy, solvation entropy, or residual loop entropy. These entropies are readily obtained from the solution measurements described in the literature and decomposed into motif parameters (e.g., parameters for base pairs, mismatches and loops of various sizes such as hairpins, internal loops, multiloops, and bulges). In addition, enthalpy values for base pairs and mismatches are exceptionally accurate and thus are also included in the NA_FF forcefield. These terms are added to the traditional forcefield terms (bond length, angle, non-bonded, etc) and weighted to avoid double counting interactions. This modified forcefield is used as part of a “total figure of merit energy” that is used to re-rank candidate three-dimensional structures (e.g., for use in the systems and methods of Section II, above).

HOMOLOGY and BUILDER programs often produce initial starting geometries that have non-physical bond lengths, van der Waals overlaps, strained bond angles, or catenated rings like two hairpins threading through each other. Such artifactual starting geometries are not well handled with traditional forcefields (like AMBER and CHARMM), which have been designed to simulate molecular configurations that are physically possible. One reason for the failure of the traditional forms is the huge energetic penalties that are assigned to long bond lengths and overlapped atoms. These energy penalties are often much larger than the non-bonded energy terms that hold a molecule in its preferred geometry and thus the MD or EM algorithms typically distort the geometry of the folded structure by a large amount to fix the bond length or overlap problem. Once the original conformation is changed so radically, there is little chance that the algorithm will reoptimize the structure to recover the correct folded conformation (unless a very long MD simulation is done). In severe cases (like overlapped whole residues), the MD simulation will break several covalent bonds and this will cause numerical non-convergence. The DSTA algorithms of the present invention provide significantly improved means for optimization of a highly distorted structure without destroying the interactions that stabilize the fold (e.g., H-bonds, electrostatic interactions, and London dispersion interactions). A novel feature of NA_FF is the way in which van der Waals interactions at short distances is handled. The usual 6-12 Lennard-Jones potential goes to huge unfavorable energies at distance below 1.5 Å, and thus actual molecules are virtually never found at such distances. To allow smooth behavior of the optimization algorithm to move the molecule to a conformation with more physical van der Waals distances, we “Switch” the functional form of the potential to an inverted parabola at distances less than 1.5 Å as follows:

$$if ( r >= 1.5 A )$$

$${E}_{VDW} = ( \frac{C 1}{{r}^{12}} - \frac{C 2}{{r}^{6}} + C 3 )$$

$$else$$

$${E}_{VDW} = ( 1.2 - \frac{0.2}{2.25} * {r}^{2} ) * {E}_{VDW} ( r = 1.5 A )$$

Where C1 and C2 are constants (that depend on the atom types) that control the well depth and width, C3 is an energy shift parameter that sets the van der Waals energy to zero at the cutoff distance (typically 12 or 15 Å). In the equation shown above for r<1.5 Å, the inverted parabola goes through r=0 Å with an energy of 20% more than the Lennard-Jones value at 1.5 Å. Such a formulation provides a gradient for the optimizer with only a small discontinuity in the first derivative at r=1.5 Å, which we find is not a problem for DSTA. Alternative embodiments use different r values for switching (e.g. r=2 Å), use different r=0 Å energy, or use a functional form different than the inverted parabola such as linear, or higher order polynomial forms that have a smaller discontinuity in the first derivative.

Another novel feature of NA_FF is the functional form used for H-bonding, which has distance, angle, and dihedral angle dependent terms as shown below:

E_{H-Bond}=C₀*E_{dist}*E_{donor}*E_{acceptor}*E_{dihedral}

where each of the terms are described in detail below. Typical H-bonds are well known to be predominantly electrostatic and partly covalent in nature. The Coulomb electrostatic part of the forcefield captures the electrostatic component of H-bonds but neglects the covalent term. In rough terms ˜80% of the energy of a typical H-bond is electrostatic and ˜20% is covalent. Thus, the C0 scaling constant is set to result in an overall H-bonding energy bonus that is approximately 25% of the pure Coulomb electrostatic value at a distance of 1.8 Å with linear H-bond geometry. In the past, a pure distance dependent H-bond term has been included in AMBER with a 10-12 Lennard-Jones functional form. We have found, however, that the 10-12 functional form is too steep and thus H-bonds are not detected at distances greater than 2.5 Å. Thus our distance dependence has a 6-10 or 4-8 Lennard-Jones functional form as follows:

$${E}_{dist .} = ( \frac{C 1}{{r}^{10}} - \frac{C 2}{{r}^{6}} ) or {E}_{dist .} = ( \frac{C 1}{{r}^{8}} - \frac{C 2}{{r}^{4}} )$$

Where r is the distance from the H donor atom to the acceptor atom and C1 and C2 are constants that depend on the atom types that are used to control the well depth and width. A small energy shift term that makes E_{dist} go to zero at the cutoff distance may also be added to prevent truncation errors. There is a problem with using a pure distance dependent H-bond term, namely that it does not take into account that actual H-bonds are significantly weaker when the geometry is nonlinear; this makes the H-bonds too strong during MD simulations when the angle is nonlinear. This artifact is one reason why H-bond terms are not used in current AMBER or CHARMM forcefields. The functional form of NA_FF takes account of all of these observations and thus does not suffer from such artifacts.

Analysis of high-resolution x-ray structures reveals that H-bonds show a distinct preference for linear H-bonding. The donor angle prefers to be 180 degrees. The acceptor functional group also show distinct angle preferences depending on the hybridization type (sp3 atom prefer acceptor angles of 108 degrees, while sp2 prefer 120 degrees and Sp1 prefer 180 degrees). In addition, sp2 hybridized functional groups, like those found in the nucleotide bases, show a strong preference for forming planer H-bonds.

To illustrate the functional form of the angle dependent term, consider the O6 to H41 H-bond of a G-C base pair. The donor angle is given by the atoms N4-H41-O6, the acceptor angle is given by C6-O6-H41, and the dihedral angle is given by C5-C6-O6-H41. Pseudocode for the angle dependent terms is shown below:

//donor angle term

if(150 < donor angle < 180)

| | |
|---|---|
| E_{donor} = 0.5 + 0.5 * cos(6*donor angle); | //maximum at |

180 degrees

else E_{donor} = 0;

//Acceptor angle term

if (acceptor == base oxygen or nitrogen or other sp2 hybrid)
{

| | |
|---|---|
| if(90 < acceptor angle < 150) | //maximum at |

120 degrees

E_{acceptor} = 0.5 + 0.5*cos(6*acceptor angle);

else E_{acceptor} = 0;

}
else if(acceptor == O1P, O2P, O3′, O5′, O4′, or O2′ or other sp3
hybrid)
{

| | |
|---|---|
| if(72 < acceptor angle < 144) | //maximum at |

108 degrees

E_{acceptor} = 0.5 − 0.5* cos(5*acceptor angle);

else E_{acceptor} = 0;

}
else E_{acceptor} = 0;

//dihedral angle term

if(135 < dihedral angle < 225 or −45 < dihedral angle < 45)

E_{dihedral} = 0.5 + 0.5 * cos(4*dihedral angle);
//maximum at 0 and 180 degrees

else E_{dihedral} = 0;

The energy terms are then multiplied together to get the total H-bond bonus energy:

E_{H-Bond}=C₀*E_{dist}*E_{donor}*E_{acceptor}*E_{dihedral}

Similar H-bond bonus energies are applied to other H-bonds in other base pairs, mismatches, and tertiary H-bonds.

The numerous parameters in force fields are determined by fitting to experimental structures and energies and/or to ab initio molecular orbital calculations. Parameters are available for simple organic molecules, the natural amino acids, and the standard nucleic acids. Current force fields yield reliable simulations of DNA and RNA containing the standard bases (Singh, U. C. & Kollman, P. A. (1984) J. Comp. Chem. 5, 129-45; Bayl), C. I., et al., (1993) Journal of Physical Chemistry 97, 10269-10280; Besler, B. H., et al., (1990) J. Comp. Chem. 11, 431-9).

Partial charges for the AMBER force field from molecular orbital calculations can be obtained using the RESP procedure (Singh, et al, 1984, supra; Bayl), et al, 1993, supra; Besler, et al., 1990, supra). Once the partial charges have been determined, any missing torsion parameters can be determined by adjusting the Vn, n and y to fit the barrier heights and periodicities obtained from ab initio molecular orbital calculations. In the AMBER force field, the partial charges are calculated by fitting to the electrostatic potential computed at the HF/6-31G(d) level of theory. Because charges for “buried” atoms are not well determined by a simple fit and since it is often desirable to impose some equivalences and constraints on the partial charges, a multi-step, restrained electrostatic potential (RESP) fitting procedure is used (Cornell, W. D., et al., (1993) Journal of the American Chemical Society 115, 9620-9631; Bayl), C. I., et al., (1993) Journal of Physical Chemistry 97, 10269-10280).

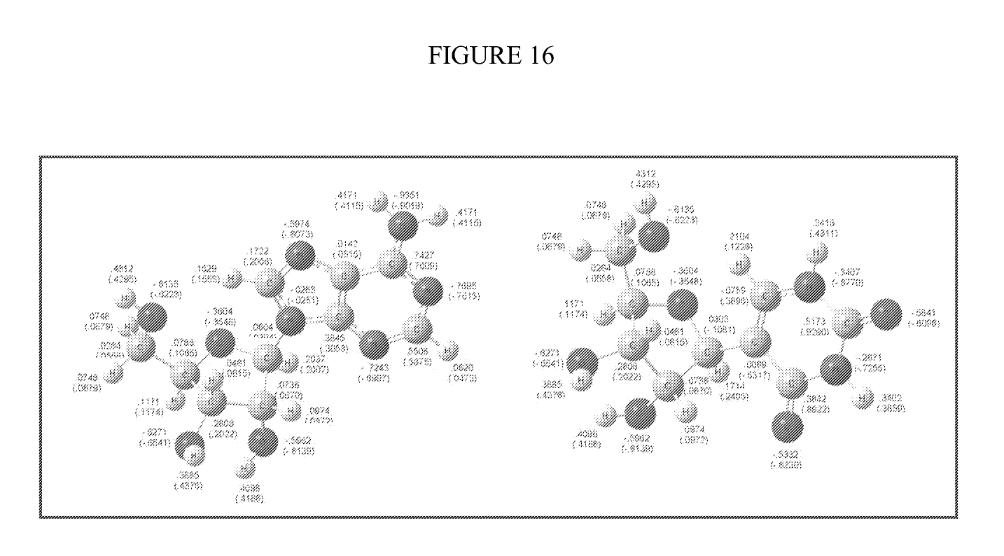

The methodology was checked against the parameters for the coded nucleotides (i.e. A, C, G, and U) that are present in the AMBER file all_nuc94. (Cornell, W. D. et al., (1995) Journal of the American Chemical Society 117, 5179-5197; Cornell, et al, (1993), supra; Case, D. A., et al., (2002) AMBER 7. University of California, San Francisco). To obtain partial charges, we closely followed the RESP (Restrained ElectroStatic Potential) methodology (Bayl), supra). Gaussian-2003 was used with the HF/6-31G* basis set to derive ESP charges and perform the geometry optimization. The Merz-Singh-Kollman scheme (Singh, U. C. et al., (1984) J. Comp. Chem. 5, 129-45; Besler, B. H., et al., (1990) J. Comp. Chem. 11, 431-9) was used for the population analysis. We reproduced the standard AMBER values for A, C, G, and U within a standard deviation of 0.03 electrons (FIG. 16), although RESP calculations on pseudouridine deviate by 0.21 electrons from the contributed values. Based on the data from the unmodified nucleosides, we believe that our charges are more appropriate than the contributed ones. The difference for pseudouridine may be due to use of a non-optimized geometry.

For the standard DNA and RNA bases in the AMBER force field, a multi-molecule and multi-conformational RESP procedure was used to determine the partial charges (Cieplak, P., et al., (1995) Journal of Computational Chemistry 16, 1357-1377). The appropriate conformations of the four nucleosides were fit simultaneously and the atoms in the sugars were constrained to have the same charges in all four nucleosides. This yielded a uniform set of partial charges for force field calculations on nucleic acids. Appropriate constraints in the RESP procedure assure that the overall charges are correct. If several conformations are possible, the RESP procedure can be used to fit a suitably weighted ensemble of conformations. In this way, a balanced set of partial charges is obtained for the modified nucleosides that is consistent with the well-tested parameters already available for the standard nucleotides.

Atom centered charges may be sufficient to determine the interaction energy of appropriately oriented hydrogen bonds, but they are not adequate for modeling their directionality. Errors of 1-3 kcal/mol are seen for energy differences between various hydrogen bond orientations, when AMBER force field calculations with atom centered charges are compared to MP2/6-31G(d) ab initio molecular orbital calculations (Cieplak, P., et al., (2001) Journal of Computational Chemistry 22, 1048-1057). This can significantly affect the prediction of the minimum energy structure, particularly for complex systems such as RNA. Force fields with distributed multipoles and/or polarizable atoms can achieve a much better description of the molecular charge distribution and potential energy surface. However, these approaches increase the calculation complexity and computation times considerably. Alternatively, the inclusion of appropriate off-center charges can readily overcome the deficiency in hydrogen bond directionality without increasing the computational cost appreciably (Cieplak, (2001), supra). Since the energy and directionality of hydrogen bonds will be important in determining the tertiary structure of RNA, an improved set of parameters will be determined by including appropriate off-center partial charges on hydrogen bond acceptors. This requires an additional RESP fit, but no additional molecular orbital calculations.

The extended AMBER forcefield can be applied to molecular dynamics simulations with explicit solvation, counterions, and PME electrostatics (Darden, T. A., et al., (1993) J. Chem. Phys. 98, 10089-92; Cheatham, T. E. et al., (1995) J. Am. Chem. Soc. 117, 4193-4194).

An optimization routine called “discrete sampling of torsion angles by rigid body rotations” or “DSTA” is used in some embodiments. In DSTA, whole segments of an RNA are rotated by discrete amounts (e.g., using 1.0 degree increments) for all dihedrals angles in a loop. For each discrete point (i.e., torsion angle) the total energy function is evaluated (including the forcefield terms as well as pseudopotentials for gaps, and H-bond constraints). For each dihedral, the best discrete torsion angle is kept. The procedure is repeated for all torsion angles until the energy function converges to a user-defined tolerance. A key observation of the DSTA optimization is that the dihedrals that are furthest from the gap site require the smallest changes to affect a large change in the gap distance and gap bond angles since the further the distance the larger the lever arm for magnifying the effect of the small dihedral change. The result of this DSTA procedure is that the gap is closed by making very small changes in the dihedrals that results in maintaining the overall architecture and favorable interactions of the loop. This procedure is effectively a sequential 1-dimensional search of an M dimensional space, where there are M dihedral angles in the loop or whole RNA/DNA and each dihedral is a separate dimension. A second embodiment of DSTA allows multidimensional optimization by the simultaneous optimization of 1 to 10 dihedrals (out of the M total) wherein each dihedral can adopt 3 values (e.g., fixed values of −1, 0, +1 degrees, or adaptive step sizes) and all 3̂N (where N is one to ten chosen dihedrals) conformations are constructed and have their energy computed and the structure with lowest energy is kept and then further rounds of optimization are similarly performed on different sets of dihedrals until convergence in energy or maximum number of steps is achieved. The choice of which dihedrals to simultaneously optimize is either chosen by the user, chosen randomly, or automatically determined based upon which nucleotides have unfavorable non-bonded energy, the close interacting nucleotides, and dihedrals that have a maximum lever arm from high energy nucleotides. The DSTA algorithm allows for smooth minimization of ill-conditioned starting structures that contain large bond lengths (due to deletions) and overlapped atoms (due to insertions) that often cause traditional minimization algorithms to break chemical bonds, to not converge, or to crash (e.g. “linmin” failures). The algorithm is called “local DTSA” when only residues in the loop are optimized. The local DSTA algorithm may also be used to optimize any nucleotide in the sequence that is in a poor conformation. These are identified by the residue energy computation by introducing “pseudo-gaps” at the P-O3′ linkage on both sides of a nucleotide and optimizing the dihedrals using local DSTA, Powell, steepest decents, conjugate gradients, or other optimization algorithm. Examples of the effects of structure morphing and DSTA optimization are shown in FIGS. 9 and 10.

For insertions and deletions within internal loops, bulges, and multi-loops, the presence of a gap may require optimization within more than one strand. If the optimization is done only on the fragments of the one strand with the gap, then this is called Local DSTA, as described above, because the optimization does not affect the global structure. If optimization is done on both strands of an internal loop or bulge (or all strands of a multiloop), then the entire structure is affected by the rigid body rotations and this is termed “Global DSTA”. In preferred embodiments, Local DSTA is first applied. If Local DSTA does not resolve all gaps, then Global DSTA is applied.

Small errors in nucleotide geometry can propagate by a “lever arm effect,” to create large errors in the global structure, even when the local geometry is quite good. This effect has been widely appreciated in the NMR field, where an abundance of local constraints such as NOE distances and dihedrals from J-couplings results in locally excellent structures but poor global properties (Wuthrich, K. (1986) NMR of Proteins and Nucleic Acids, Wiley, New York). For NMR, this problem has been largely solved by the inclusion of residual dipolar couplings (Zhou, H., et al., (2000) Biopolymers 52, 168-180). In applications wherein there is a sufficient starting structure, and through the use of supercomputer resources, the current forcefield methods such as AMBER may find refined structures consistent with experiments. A more efficient algorithm for refining the rough structures produced by the de novo and NA_HOMOLOGY programs is needed. Such refinement may be provided using a “cone optimization algorithm”. In the cone optimization algorithm, the roll, tilt, and twist of base pair i-j is determined with respect to base pair i−1, j+1, using standard methodology for defining the helix axis (Lu, X.-J. & Olson, K. W. (2003) Nucleic Acids Res 31, 5108-21). Rigid body rotations of the residues i through j are then performed while sampling different roll, tilt, and twist values within a range of values. The i−1, j+1 pair serves as a pivot point. A pseudopotential term is created that penalizes the structure as it moves further away from the original starting roll, tilt, and twist geometry of the closing base pair. The total energy of the molecule is computed for each trial and the conformation with the best energy is kept. The local DSTA algorithm is used to address discontinuities in bond lengths and angles introduced at the cone pivot point. The cone optimization is performed at all base pair steps in an iterative fashion until the energy converges. Such cone optimization of structures may also be used to probed more refined structures for AMBER MD simulations, thereby shortening the time required for final refinement.

A novel “anchor points” approach is also implemented in which a given set of residues may be fixed in three-dimensional space by using a quadratic pseudopotential that penalizes the energy function if a structure during minimization moves an anchored residue away from its original position. Such anchoring allows for the orientation of intermolecular interactions of an RNA with other molecules to be retained. An important concept in homology modeling is that 3D coordinates of critical residues are generally conserved, while details of the overall structure can often be variable. Critical residues often participate in intra-molecular or inter-molecular interactions that are important for function, and thus the structures related to these residues tend to be highly conserved. Use of Global DSTA, described above, to close gaps can often dramatically improve the local geometry but can corrupt the global fold. For example, in performing homology modeling of the D. radiodurans 5S rRNA using 1 JJ2 as the reference, the two hairpins (residues 36-50 and 88-93 in FIG. 15) are correctly placed before optimization of the adjacent gaps. After Global DSTA optimizations, however, the hairpins may be rotated away from their original positions. “Anchoring” conserved features of the structure allows optimization of the gaps while maintaining the positions of conserved residues. In applying anchors, the critical residues to be held invariable (i.e., the “anchors”) are first identified. The anchors are then incorporated as pseudopotential constraints for the forcefield calculations.

### Identification of Anchors.

If a multiple sequence alignment (MSA) is available (true for many biological RNAs), nucleotides that are highly conserved are likely to be critical. In some embodiments, software can receive human input to automatically identify such critical residues without invoking an MSA.

SBSA identifies a population of conserved residues in the two sequences but not all are likely to be critical residues. Critical residues are nearly always in unpaired regions, so the initial population of conserved residues is further filtered to identify residues that are not Watson-Crick paired.

Additional selection criteria may be optionally applied. For example, in some embodiments it may be desirable to set a distance cutoff from the nearest deletion or insertion. For example, if the cutoff is 5 nucleotides, then nucleotides could only be considered critical if they are more than 5 nucleotides away from a deletion or insertion. In some embodiments, it may be desirable to filter out nucleotides that do not form intramolecular interactions, such that nucleotides likely to form such interactions (e.g., “flipped out” residues) are identified as critical. Criteria such as these would correctly identify critical residues in the hairpins of 5S rRNA that interact with the 23S rRNA, and critical residues in loop E of 5S rRNA that are known to interact with the L25 protein. A heuristic equation can be used to give weights to all such features such that an overall score indicating the probability of a residue being critical can be generated. Such an heuristic equation may be trained using a large dataset of aligned residues such as the residues in ribosomal rRNAs, where the critical residues are known from multiple sequence alignment.

### Applications of Anchors

“Anchor pseudopotentials” penalize the energy function of a structure as it moves anchor residues away from their conserved positions during energy minimization or molecular dynamics. One functional form for an anchor hyperbolic pseudopotential is given below:

E(anchor)=K_{A}*Σ((Xᵢ−Xᵢ°)²+(Yᵢ−Yᵢ°)²+(Zᵢ−Zᵢ°)²+b²)^{1/2}−b)

where KA is the empirically optimized anchor force constant, b is a constant that controls the linear slope at large deviations, X i°, Y i°, and Z i° are the coordinates of each atom i in the anchor positions, and Xi, Yi, and Zi are the coordinates of the current structure. This functional form prevents over penalization of structures for large deviations.

Anchor pseudopotentials can be applied in analyses of RNA complexes with both proteins and metals. For example, tRNA is known to interact with its cognate synthetase protein through specific interactions and these interactions affect the shape of the tRNA—namely the angle of the “L” changes. Thus the effect of the synthetase can be model by freezing these interaction sites by declaring them to be anchor points. Such interactions between RNA and proteins can be generally modeled using anchors. The effects of metal that chelate RNA can also be modeled using anchors by freezing the positions of nucleotides known to interact with a magnesium or other metal observed in a crystal structure (or known from another experimental method). An additional example is the ribosomal RNAs, which interact with multiple proteins. The ribosomal proteins from different organisms are often quite divergent, but generally interact with RNA in similar fashion. Thus, the RNA component of a ribosome can be accurately modeled in different organisms, even if the protein structures in the reference and query organisms are very different. Further extensions, of the nucleic acid modeling platform described herein are possible including the inclusion of protein homology modeling and de novo modeling. This approach allows ribonucleo-protein complexes to be accurately predicted.

Divalent and monovalent metals play essential roles in stabilizing the proper folds of RNA and participating in catalysis. High-resolution crystal structures of RNA and DNA often reveal the locations of stably bound hydrated multivalent metals such as magnesium and manganese, and occasionally monovalent metals such as potassium and sodium. The locations of metals in the structure of one sequence are probably approximately conserved in homologous sequences. Thus the locations of metals can be retained in homology models, which serve as starting points for AMBER. The locations of solvent molecules and metals also play crucial stabilizing roles in individual motifs, which will be included in the motif database used in de novo prediction. Crystal structures rarely reveal all of the counterions involved in stabilizing an RNA fold, however. Theoretical methods for computing the likely locations of remaining metals may be incorporated into the process (Misra, V. K. & Draper, D. E. (2000) J. Mol. Biol. 299, 813-25; Auffinger, P., et al., (2003) Chem. Biol. 10, 551-61; Jayaram, B., et al., (1990) Macromolecules 23, 3156-65). Non-linear Poisson-Boltzmann methods for computing electrostatic potential around a biomolecule (Jayaram, et al., supra; Boschitsch, A. H., et al., (2002) J. Phys. Chem. B 106, 2741-54; Sharp, K. A. & Honig, B. (1995) Curr. Opin. Struct. Biol. 5, 323-328; Record, M. T., et al., (1998) Adv. Protein Chem. 51, 281-353) may also be incorporated into the structural bioinformatics process. In some embodiments, NLPB is used to compute an electrostatic potential, then a Monte Carlo search method is used to place hydrated metals in the vicinity of the most negative charge potential in random orientations (Jayaram, et al, supra; Young, M. A., et al., (1997) J. Am. Chem. Soc. 119, 59-69) to facilitate accurate MD simulations.

### V. Structure Based Sequence Alignment and Threading of Nucleic Acids.

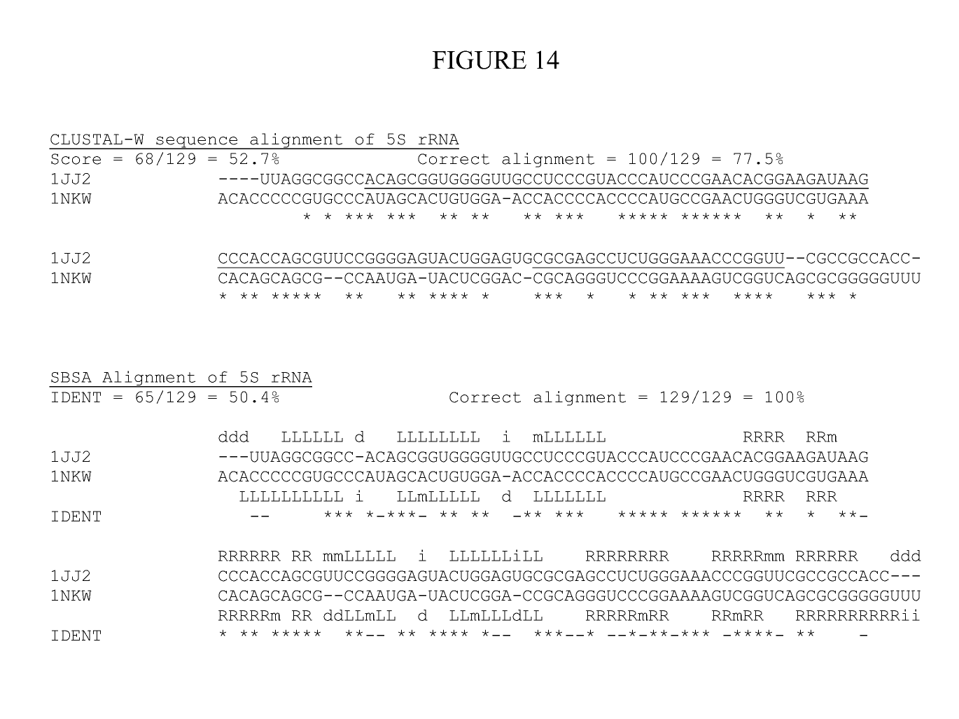

The present invention provides a set of novel algorithms for aligning nucleic acid sequences. Traditional sequence alignment uses sequence similarity scoring matrices to perform alignment. Alignment of 5S rRNA using CLUSTAL-W shows that only 77% of the residues are correctly aligned. The reason for the failure is that RNA sequences conserve their secondary structure and the identity of their single stranded loop regions. Thus, the base paired regions are not conserved at the sequence level but at a higher level (namely secondary structure). The algorithm of the present invention fully accounts for the nucleic acid secondary structure in the alignment process. This approach is called “structure based sequence alignment” (SBSA). FIG. 14 shows the correct sequence alignment derived using the SBSA algorithm of the present invention. The structures shown in FIG. 15 show that the SBSA algorithm of the present invention correctly placed nucleotides such that the correct secondary structure is represented. Importantly, sequence alignment by this method is equivalent to claiming that two nucleotides that are aligned occupy the same location in three-dimensional space. Thus this provides a method for determining the threading of a sequence into a known three-dimensional structure. This in turn is used for homology modeling (Section I, above).

There are three different preferred implementations of SBSA: 1. The secondary structures are known for both reference and query sequences, 2. The secondary structure is only known for the reference template, and 3. The secondary structure is unknown for both reference and query sequences. The alignments obtained are most reliable for case 1, and least reliable for case 3. Note that the final alignments may be manually optimized to insure proper placement of gaps, before inputting into the homology (Section I) or the de novo (Section II) algorithms.

Case 1: The secondary structures are known for both reference and query sequences (from phylogenetic analysis or from analysis of the three-dimensional structure). The algorithm starts by creating new strings for both sequences in which the nucleotide participating in pairs (both matches and mismatches) are replaced by the letters L and R. The resulting strings are called the “edited reference” and “edited query” strings. This novel process of editing the paired residues prevents incorrect alignment of the paired residues and yet retains their positions and allows for correct placement of insertions and deletions in the loop regions (i.e., unpaired or single stranded regions). Next, the edited reference and edited query strings are aligned using a dynamic programming algorithm similar to the Gotoh modification of the Needleman-Wunsch type global alignment algorithm (Needleman, S. B. & Wunsch, C. D. (1970) J. Mol. Biol. 48, 443-53; Gotoh, O. (1982) J. Mol. Biol. 162, 705-8.) using the scoring matrix in Table 2, below. Note that the scoring matrix favorably scores nucleotide identities (A-A, C-C, G-G, and U-U) and pairs (R-R and L-L), but heavily penalizes R-L and L-R substitutions. In addition, transition mutations (A-G, G-A, C-T, T-C) are scored more favorably than transversion mutations (A-C, C-A, A-U, U-A, C-G, G-C, G-U, U-G), because conservation of purine or pyrimidine is often functionally important due to size and stacking considerations and thus evolutionarily conserved. Also note that A-C and C-A are more favorable than the other transversions because they conserve the H-bonding pattern and this substitution is quite common in the single stranded regions of biological RNAs. The method described can use different scoring matrices, which may be optimized for specific classes of RNAs (tRNA, 16S rRNA, 23S rRNA, etc.).

The alignment is achieved by a dynamic programming algorithm in which two alignment matrices, M and M′ are created. M is the alignment matrix with terminal gap penalties equal to internal gap penalty. M′ is the alignment matrix in which the sequence fragments are scored with the terminal gap penalty set to zero (but internal gaps are still penalized by way of the gaps found in M(i, j), M(i, j−1), M(i−1, j). The sequences are numbered consecutively as 1≦i<j≦N. The elements M(i, 0) and M(0, j) are initialized to zero for all i and j. The elements in the alignment matrices, M(i, j) and M′(i, j), are optimized according to the following recursive equations (this is called the “fill algorithm”):

M(i,j)=max{M(i−1,j−1)+S(Xi,Xj),M(i−1,j)+W,M(i,j−1)+W}//with terminal gaps penalized

M′(i,j)=max{M(i−1,j−1)+S(Xi,Xj),M(i,j−1),M(i−1,j)}//terminal gap has no penalty.

Where M(i, j) is the score for the fragment l to i of the reference sequence and fragment l to j of the query sequence. Xi is the identity of the nucleotide at position i in the reference string and Xj is the identity of the nucleotide at position j in the query string. S(Xi, Xj) is the substitution score from Table 1 in FIG. 13. W is the gap penalty which is given by the affine equation:

W=gap opening+(n−1)*gap extension
Where n is the number of nucleotides in the gap.
   The sequence alignment is then obtained by the usual traceback algorithm using the M and M′ matrices. Alternative embodiments of the alignment algorithm are to use a local alignment algorithm like Smith-Waterman or to use dot plot optimization using scoring matrices similar to Table 2.

Case 2: The secondary structure is only known for the reference template (by analysis of the coordinates). The alignment proceeds initially identically to case 1, with the reference template edited to replace paired residues with L and R characters. The edited reference string is then aligned with the unedited query string using the fill algorithm from case 1 and the substitution matrix shown in Table 2. Next, the pattern of LLL and RRR stretch is analyzed to determine the hierarchy of pairing so that a tree diagram may be determined. The roots of the hierarchal tree have the largest difference between nucleotide positions and the leaves have the smallest difference and the branches have intermediate differences between nucleotide positions. The tree from the reference sequence is then superimposed on the query sequence using the preliminary alignment. Base pairs in the query string are then confirmed (e.g., does and L-R pair found in the reference correspond to a Watson-Crick or G-U or, U-G pair in the query) in the order specified by the tree (e.g., start with hairpins, then in decreasing order Watson-Crick pairs, mismatches, internal loops, bulges, multiloops, and bifurcations last). The query may have more or less pairs then found in the reference, and thus the algorithm proceeds by checking i+1, j−1 in the query until a mismatch is found. The algorithm only keeps the length of the paired region corresponding to the maximum length found in the reference (this prevents accidental over extension of the stems which would compromise the subsequent steps of the algorithm). A combinatorial number of paired alignments can be contemplated in which the paired regions are “slipped” with respect to one another or gaps are present. The first slipped alignment of pairs to consider is the one specified by the current sequence alignment. Alternative alignments are then considered in the order in which slipped orientations with the minimum number of gaps are considered first. If the query is found to contain a consecutive series of pairs, then a new edited query string is created in which the query has paired residues replaced by L and R. The new string is then realigned with the edited reference and the new alignment is used to generate a new tree. The process is repeated until all paired regions in the tree have been examined. At this point, proper alignment of most of the paired regions and the conserved unpaired regions are obtained. In the edited query string, the paired positions are used to generate a list of pairing constraints and the matched aligned loop regions are used to generate a list of unpaired constraints. These constraint lists are used in the thermodynamic DPA (e.g., Visual OMP) to obtain the remaining pairs. The new pairs discovered by the thermodynamic DPA are then used to obtain a final edited query string with all L and R substitutions present. The final edited query string is then aligned against the edited reference string to obtain the final sequence alignment. It should be appreciated that there are alternative alignment strategies for aligning a sequence against a known secondary structure consensus.

Case 3. The secondary structure is unknown for both reference and query sequences. This proceeds using an iterative procedure similar to that described for case 2. This method, however, does not have a guide secondary structure for the reference string. Thus, the secondary structure of both sequences are obtained iteratively. The algorithm starts by aligning the two sequences using the unedited reference and query strings using the algorithm from case 1 and substitution matrix in Table 2. The longest substring with the highest score is then constrained to be single stranded in the thermodynamic DPA. The two secondary structures obtained are then compared and all the pairs found in the two structures that are identical are kept and changed to R and L in edited reference and edited query strings. These are then aligned and the next longest and highest scoring substring is identified. This new string is then constrained to be single stranded along with the previously determined single stranded regions. The sequences are then repeatedly folded by the thermodynamic DPA and by the sequence alignment algorithm, until the thermodynamic algorithm generates secondary structures for both reference and query string that have the same tree diagram (order of LLL and RRR stretches). The final list of pairs is then used in to edit the reference and query strings with R and L to obtain a final sequence alignment. Note that during the iterative process, it is possible that residues that were once paired might become unpaired or vice versa; this prevents the overall case 3 algorithm from getting stuck in a local minimum. Also note that the case 3 algorithm is less reliable than case 2 or case 1, and thus manual refinement of the alignment may be desired. Alternative, structure based alignment algorithms have been proposed in the literature (Mathews, D. H. & Turner, D. H. (2002) J Mol Biol 317, 191-203), but used substitution matrices that are not as effective as the one shown in Table 2. Note that occasionally phylogenetic multiple sequence alignments reveal mismatches that are replaced in other organisms as a Watson-Crick pair or other mismatch. Such mismatch cases, M, are scored similarly to the R and L scoring given in Table 2.

TABLE 2
Substitution Scoring Matrix for Structure
Based Sequence Alignment

| | | Top Sequence | | | | | | |
|---|---|---|---|---|---|---|---|---|
| | | A | C | G | U | R | L | M |
| Bottom | A | 1 | 0.4 | 0.5 | 0.1 | 0.1 | 0.1 | 0.1 |
| Sequence | C | 0.4 | 1 | 0.1 | 0.5 | 0.1 | 0.1 | 0.1 |
| | G | 0.5 | 0.1 | 1 | 0.1 | 0.1 | 0.1 | 0.1 |
| | U | 0.1 | 0.5 | 0.1 | 1 | 0.1 | 0.1 | 0.1 |
| | R | 0.1 | 0.1 | 0.1 | 0.1 | 2 | −2 | 1 |
| | L | 0.1 | 0.1 | 0.1 | 0.1 | −2 | 2 | 1 |
| | M | 0.1 | 0.1 | 0.1 | 0.1 | 1 | 1 | 2 |

Gap Opening = −0.5
Gap Extension = −0.1
Terminal Gap = 0

The flowchart of the NA_HOMOLOGY algorithm is shown in FIG. 4. In some embodiments, the SBSA code is integrated into the NA_HOMOLOGY program. In some embodiments, procedures for closing the gaps and removing the overlaps comprises: 1) running the local DSTA algorithm, 2) running the global DSTA algorithm, 3) running BUILDER to replace the closing pairs and gap with a motif in the fragment database, and 4) running the cone optimization algorithm (described in Section IV). These algorithms can be integrated into NA_HOMOLOGY so that computations are automatic and create structures that are well-conditioned for full-scale AMBER MD computations to refine the structures. In some embodiments, NA_HOMOLOGY is configured to try all of the different optimizations at each of the deletion/insertion sites, to evaluate their overall non-bonded forcefield energy, and to choose the optimized structure at each site with the lowest energy. In some preferred embodiments, NA_HOMOLOGY comprises an iteration step that will make more than one pass at optimizing each of the deletions and insertions. In additional embodiments, the NA_HOMOLOGY program is configured to automatically identify conserved H-bonds and to incorporate “Anchors”.

### VI. Identification of Conserved Hydrogen Bonds.

The BP_GEOM algorithm determines all hydrogen bonds in a nucleic acid structure. These hydrogen bonds are then analyzed by BP_GEOM to determine the nucleotides participating in Watson-Crick base pairs, mismatches, base-backbone interactions, and backbone-backbone interactions. In confirming the presence of a Watson-Crick pair, the co-planarity of the participating bases is computed. The equation of the plane of a base i is determined from the XYZ coordinates of C6-N1-C2 of purines (A and G) and from C4-N3-C2 of pyrimidines (C, U, and T). The minimum distance between the plane of one base and the point N3 or N1 of the paired base is determined by standard geometry methods. If the interplaner distance is less than 2 Å and all H-bonds are less than 3.5 Å (distances for O6-N4, N1-N3, and N2-O2 for G-C pairs and N6-O4 and N1-N3 for A-U pairs), a putative base pair is declared to be a Watson-Crick pair. The co-planarity constraint avoids the output of false positive base pairs that are highly buckled or twisted, consecutive in the sequence, or stacked in the structure. The H-bond and co-planarity thresholds may be set to tighter or looser values if desired.

The algorithm also identifies if the H-bonds found in the reference template are also present (i.e., conserved H-bond) in the homology model sequence (Section I). An H-bond is considered “conserved” if a D-A H-bond pair is found at the same XYZ coordinates within a defined error tolerance (e.g., typically 3.0 Å) for both the reference structure and the homology model of the query sequence. These are used in the minimization (or molecular dynamics) of the homology model as constraints to maintain the important interactions but to minimize the energy of less important nucleotides. The algorithm is also useful for extracting the secondary structure from a three-dimensional structure. The secondary structure is then useful for performing the SBSA (Section V). Note that the secondary structure derived by this method is more reliable than the phylogenetic secondary structure since it represents a single state of the nucleic acid rather than a superposition of states as is present in the phylogenetic structure (i.e., the phylogenetic structure is the superposition of all structural states that are required for function). The algorithm then determines those Watson-Crick pairs that are part of the secondary structure and those that result from pseudoknots. The pseudoknots are identified by computing the number of chord crossings for all pairs in a Nussinov plot (by checking the conditions for i-j and k-l pairs: if i<k<j<l or k<i<l<j then a chord crossing is identified), and iteratively removing base pairs with the highest number of chord crossings from the base pair list.

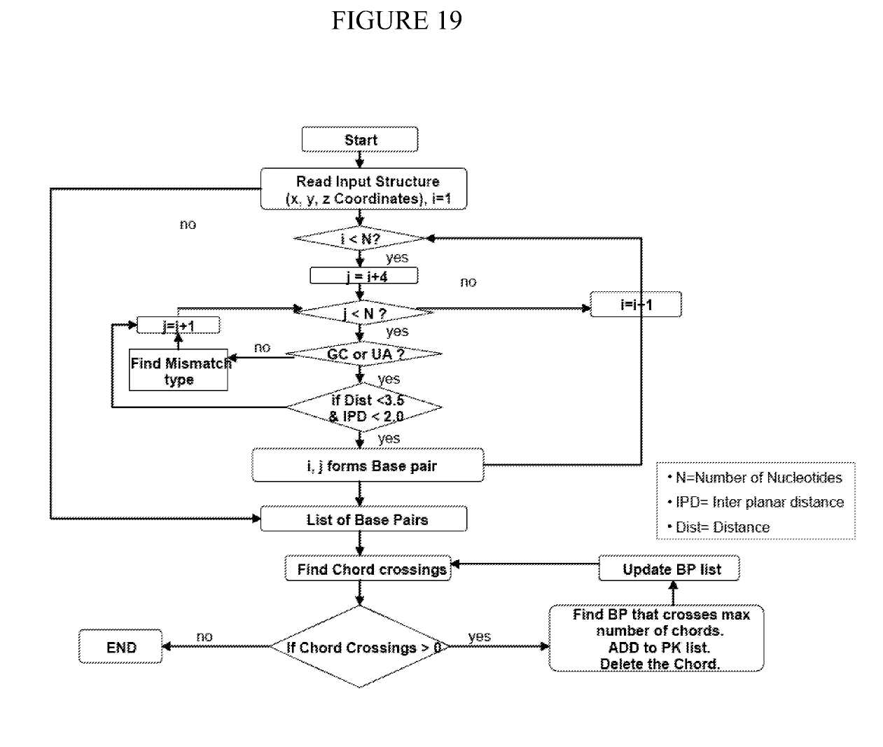

A summary of certain preferred embodiments of the systems and methods are shown in FIG. 19.

### VII. Systems of the Present Invention

The methods of the present invention are implemented in a wide variety of systems and settings. In some preferred embodiments, the methods are conducted using software run on a computer processor to carry out the algorithms. While in preferred embodiments, the methods are carried out in an automated format, entirely within a computer processor, it should be understood that one or more components may be carried out by a human and that the methods may involve human interaction or intervention at one or more points.

The computer processor for conducting the methods of the present invention may be housed in any type of device, including, but not limited to, desktop computers, scientific instruments, hand-held devices, personal digital assistants, phones, medical instruments, implanted devices (e.g. in vivo), and the like. The methods need not be carried out on a single processor. For example, one or more steps may be conducted on a first processor, while other steps (simultaneously or sequentially) are conducted on a second processor. The processors may be located in the same physical space or may be located distantly. In some such embodiments, multiple processors are linked over an electronic communications network (e.g., an Internet).

In some preferred embodiments, the processors are associated with a display device for showing the results of the methods to a user or users. In some embodiments, the results comprise a video image of a predicted structure. In some embodiments, the results comprise coordinates of atoms, molecules, or motifs. In some embodiments, the results comprise a yes/no type answer to a specific question (e.g., for medical diagnostic tests).

The processors of the present invention may also be directly or indirectly associated with information databases. In some embodiments, the databases comprise sequence information (e.g., public or private nucleic acid sequence databases such as GENBANK). In some embodiments, the databases comprise structure databases, such as those described above. In yet other embodiments, the database comprises information pertaining to drugs, medical conditions, and/or patient-specific information.

### EXPERIMENTAL

The following examples serve to illustrate certain preferred embodiments and aspects of the present invention and are not to be construed as limiting the scope thereof.

### Example 1

This example describes the use of the systems and methods of the present invention to provide improved structure analysis compared to the previously available methods. There are several examples in the literature of failed attempts to predict tRNA structure (Hubbard, J. M. & Hearst, J. E. (1991). Biochemistry 30, 5458-5465). Thus, prediction of tRNA tertiary structure is particularly suited to demonstrate the efficacy of the methods of the present invention.

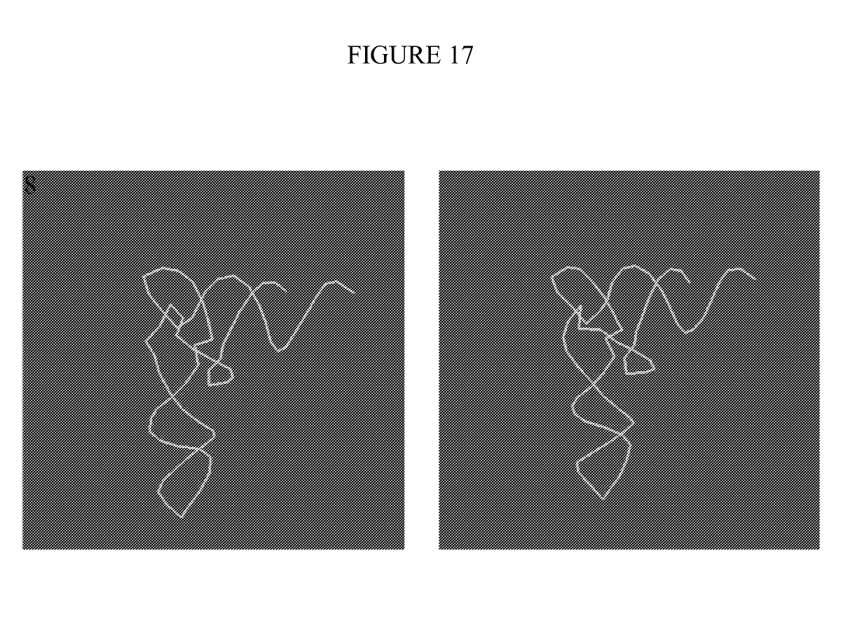

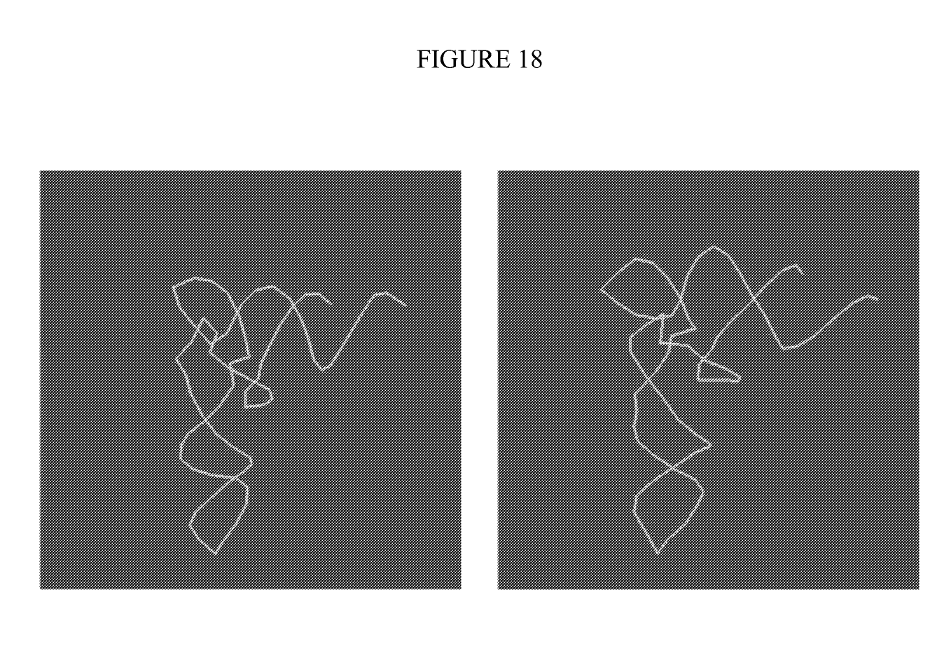

To illustrate embodiments of the present invention, a number of methods were used: manual sequence alignment, methods of the present invention described in Section I for nucleotide substitution (“threading method”), and methods of the present invention described in Section II for de novo prediction (“de novo method”) for a limited manually constructed database of structural motifs based on only four structures (tRNAphe: 1EHZ, group I intron: 1HR2, T. thermophilus 30S ribosome: 1J5E, and H. marismortui 50S ribosome: 1JJ2). The results for the threading and de novo methods are shown in FIGS. 17 and 18. The all-atom RMSD for experimental vs. predicted structures are 2.4 and 3.8 Å, respectively for threading and de novo prediction. These predictions represent improvements over the previous history of failed attempts at tRNA structure prediction.

### Example 2

This Example describes the use of the systems and methods of the present invention for design of therapeutic molecules. Knowledge of the structure of pathogen ribosomes is important for development of new narrow-spectrum (species-selective) antibiotics as well as broad-spectrum antibiotics. According to the CDC, the majority of hospital-acquired infections involve drug-resistant pathogens. Of particular concern are drug-resistant Pseudomonas aeruginosa, Enterococcus, Escerichia coli, Staphylococcus aureus, and Mycobacterium turberculosis. Development of new drugs against bioterrorism agents including Bacillus anthracis, Francisella tularensis, Yersinia pestis, and Salmonella typhimurium are particularly important in view of the risks of bioterrorism. Drug development would benefit highly from the availability of ribosome structures for different organisms.

Recently, a number of ribosome crystal structures that have been determined (Wimberly, B. T. et al., (2000) Nature 407, 327-39; Ban, N., Nissen, P., et al., (1999) Nature, 400, 841-847; Cate, J. H., et al., (1999) Science, 285, 2095-2104; Yusupov, M. M., et al., (2001) Science 292, 883-896; Ban, N. et al., (2000) Science 289, 905-921; Harms, J. et al., (2001) Cell 107, 679-688). The ribosome is responsible for protein synthesis in all organisms. About half of all clinically used antibiotics target the ribosome. Despite wide efforts, the only organisms that have had their ribosome structures determined at atomic resolution are the thermophilic bacterium Thermus thermophilus (high resolution of the 30S, and low resolution of the 70S), the acheaon Haloarcula marismortui (high resolution of 505 only), and the eubacterium Deinococcus radiodurans (high resolution of 505 only). Thus there is a need to predict the structures of other pathogenic prokaryotes and eukaryotes as well as the human ribosome. To date, software has not existed that could use the known ribosome structures to model the structures of ribosomes from homologous organisms and account for the substitutions, deletions, and insertions as well as chemical modifications in the ribosomes of other organisms. The systems and methods of the present invention provide tools for modeling complex nucleic acid molecules using known structures of homologous nucleic acids, e.g., from other organisms, and for modeling complex nucleic acid de novo, e.g., by reference to databases of known structural motifs.

All publications and patents mentioned in the above specification are herein incorporated by reference. Various modifications and variations of the described methods and systems of the invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention that are obvious to those skilled in the relevant fields are intended to be within the scope of the following claims.

We claim:

1. A system for generating a corrected three-dimensional model of nucleic acids, comprising a processor configured to:
a) generate an initial, uncorrected model of a test sequence by comparison to a reference sequence;
b) align secondary structure constraints of a reference sequence with a test sequence to generate an aligned sequence;
c) make substitutions, deletions, and insertions dictated by said aligned sequence using geometrical computation algorithms for said substitutions and using molecular mechanics and molecular dynamics algorithms to close gaps caused by said deletions and insertions;
d) identify conserved hydrogen bonds present in both said reference sequence and said uncorrected model to select hydrogen bond constraints; and
e) optimize said uncorrected model using a forcefield algorithm that accounts for said hydrogen bond constraints to generate a corrected three-dimensional model of said test sequence.

2. A method for generating a corrected three-dimensional model of nucleic acids, comprising the step of submitting a test sequence to the system of claim 1 under conditions such that a corrected three-dimensional model of said test sequence is generated.

3. A system for refining nucleic acid structure predictions, comprising a processor configured to:
a) generate an initial, uncorrected model of a test sequence by comparison to a reference sequence;
b) align the reference sequence with the test sequence using secondary structure constraints to generate an aligned sequence;
c) make substitutions, deletions, and insertions dictated by the aligned sequence using geometrical computation algorithms for the substitutions and using molecular algorithms to close gaps caused by the deletions and insertions;
d) automatically identify conserved hydrogen bonds present in both the reference sequence and the uncorrected model to select hydrogen bond constraints;
e) allow input of other constraints determined by experimental or theoretical techniques, said other constraints comprising one or more of distances, dihedral angles, bond vectors, electron density, and accessibility to chemical modifying agents; and
f) optimize the uncorrected model using a forcefield algorithm to generate a corrected three-dimensional model of the test sequence that is consistent with selected and input constraints.

4. A method for generating a corrected three-dimensional model of nucleic acids, comprising the step of submitting a test sequence to the system of claim 3 under conditions such that a corrected three-dimensional model of said test sequence is generated.
